(19) United States
(12) Patent Application Publication
(10) Pub. No.: US 2025/0376349 A1
(43) Pub. Date: Dec. 11, 2025

(54) MEDIUM PROCESSING APPARATUS AND IMAGE FORMING SYSTEM

(71) Applicant: Kazuki OTA, Kanagawa (JP)

(72) Inventor: Kazuki OTA, Kanagawa (JP)

(73) Assignee: Ricoh Company, Ltd., Tokyo (JP)

(21) Appl. No.: 19/217,714

(22) Filed: May 23, 2025

(30) Foreign Application Priority Data
Jun. 10, 2024 (JP) 2024-093984

(51) Int. Cl. B65H 37/04; G03G 15/00

(52) U.S. Cl. CPC B65H 37/04; G03G 15/6544; B65H 2301/5142; B65H 2301/51616

(57) ABSTRACT

A medium processing apparatus includes a liquid applier including a liquid application member to apply liquid to a medium through the liquid application member, and a postprocessor to execute post-processing on a medium bundle including the medium to which the liquid is applied. In the medium processing apparatus, the liquid applier moves the liquid application member to contact the medium and apply the liquid to the medium, and adjusts a position of the liquid application member on the medium to make an amount of the liquid applied from the liquid application member to the medium constant before and after the liquid application member is worn.

### CROSS-REFERENCE TO RELATED APPLICATION

This patent application is based on and claims priority pursuant to 35 U.S.C. § 119 (a) to Japanese Patent Application No. 2024-093984, filed on Jun. 10, 2024, in the Japan Patent Office, the entire disclosure of which is hereby incorporated by reference herein.

### BACKGROUND

### Technical Field

The present disclosure relates to a medium processing apparatus and an image forming system.

### Background Art

A plurality of sheet media are stacked on top of each other to form a sheet bundle, and medium processing apparatuses have been proposed that perform prescribed processing on a sheet bundle. As such prescribed processing, for example, binding is performed by the medium processing apparatuses. In the related art, binding with metal staples to form a sheet bundle has been proposed. Currently, medium processing apparatuses have been proposed that perform binding without metal staples from the viewpoint of saving resources and reducing environmental load. Such binding without staples is referred to as stapleless binding.

Typically, stapleless binding that involves so-called crimp binding to clamp a sheet bundle with serrate binding teeth and presses and deforms the sheet bundle is adopted. Typically, sheets of paper are used as sheet media. In the following description, a bundle of sheets that is an example of a plurality of media may be referred to as a sheet bundle.

In the present disclosure, binding with metal staples may be referred to simply as stapling, and stapleless binding may be referred to as crimp binding or crimping.

In order to increase the binding strength when crimp binding is performed, technologies to apply liquid to a sheet bundle may be employed. In such technologies, for the purposes of stabilizing the amount of liquid to be applied to a sheet bundle, the amount of the liquid applied to the sheets is controlled to have a desired value even if the number of the sheets that make up a sheet bundle or the type of the sheets varies.

### SUMMARY

The present disclosure described herein provides a medium processing apparatus including a liquid applier with a liquid application member to apply liquid to a medium through the liquid application member, and a postprocessor to execute post-processing on a medium bundle including the medium to which the liquid is applied.

In the medium processing apparatus, the liquid applier moves the liquid application member to contact the medium and apply the liquid to the medium, and adjusts a position of the liquid application member on the medium to make an amount of the liquid applied from the liquid application member to the medium constant before and after the liquid application member is worn.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1 is a diagram illustrating an overall configuration of an image forming system.

FIG. 2 is a diagram illustrating an internal structure of a post-processing apparatus according to a first embodiment of the present disclosure.

FIG. 3 is a schematic view of an upstream side of an edge binder of the post-processing apparatus of FIG. 2 in a conveyance direction.

FIG. 4 is a schematic view of an edge binder viewed from a liquid applier in a main scanning direction.

FIG. 5A and FIG. 5B are schematic diagrams illustrating a configuration of a crimper of an edge binder.

FIG. 6 is a schematic view of a staple binder viewed from an upstream side in a conveyance direction.

FIG. 7 is a schematic view of a staple binder according to a modification, viewed from an upstream side in a conveyance direction.

FIG. 8 is a block diagram illustrating a hardware configuration of the post-processing apparatus according to the first embodiment, to control the operation of the post-processing apparatus.

FIG. 9 is a flowchart of the binding performed by an edge binder.

FIG. 10A to FIG. 10D are diagrams illustrating the positions of a liquid applier and a crimper during the binding performed by an edge binder.

FIG. 11A to FIG. 11H are diagrams illustrating the positions of a liquid applier and a crimper during the binding performed by an edge binder.

FIG. 12A and FIG. 12B are diagrams illustrating a liquid application member that is worn, according to a comparative embodiment.

FIG. 13A to FIG. 13C are diagrams illustrating a liquid applier according to a first example.

FIG. 14 is a flowchart of adjustment for a liquid application member according to the first example.

FIG. 15 is a flowchart of adjustment for a liquid application member according to the first example.

FIG. 16A to FIG. 16C are diagrams illustrating a liquid applier according to a second example.

FIG. 17 is a flowchart of adjustment for a liquid application member according to the second example.

FIG. 18 is a flowchart of adjustment for a liquid application member according to the second example.

FIG. 19A to FIG. 19C are diagrams illustrating a structure and operation of a liquid applier according to the second example.

FIG. 20A to FIG. 20C are diagrams illustrating a structure and operation of a liquid applier according to the second example.

FIG. 21A to FIG. 21C are diagrams illustrating a liquid applier according to a third example.

FIG. 22 is a flowchart of adjustment for a liquid application member according to the third example.

FIG. 23 is a flowchart of adjustment for a liquid application member according to the third example.

FIG. 24A to FIG. 24C are diagrams illustrating a liquid applier according to a fourth example.

FIG. 25 is a diagram illustrating a liquid applier according to a fourth example.

FIG. 26A and FIG. 26B are diagrams illustrating a liquid applier according to the fourth example.

FIG. 27 is a flowchart of adjustment for a liquid application member according to the fourth example.

FIG. 28 is a flowchart of adjustment for a liquid application member according to the fourth example.

FIG. 29A to FIG. 29C are diagrams illustrating a liquid applier according to a fifth example.

FIG. 30A and FIG. 30B are diagrams illustrating a pushing member according to the fifth example.

FIG. 31 is a diagram illustrating an operation of a pushing member according to the fifth example.

FIG. 32 is a flowchart of adjustment for a liquid application member according to the fifth example.

FIG. 33 is a flowchart of adjustment for a liquid application member according to the fifth example.

FIG. 34 is a flowchart of adjustment for a liquid application member according to the fifth example.

FIG. 35 is a flowchart of adjustment for a liquid application member according to the fifth example.

FIG. 36A to FIG. 36F are diagrams illustrating a liquid applier according to a sixth example.

FIG. 37 is a flowchart of adjustment for a liquid application member according to the sixth example.

FIG. 38 is a flowchart of adjustment for a liquid application member according to the sixth example.

FIG. 39 is a diagram illustrating an internal configuration of a post-processing apparatus according to a second embodiment.

FIG. 40A to FIG. 40C are schematic views of an internal tray according to the second embodiment, viewed from the thickness direction of a sheet.

FIG. 41 is a schematic view of an upstream side of a crimper of the post-processing apparatus of FIG. 39 in a conveyance direction.

FIG. 42A and FIG. 42B are schematic views of a liquid applier of a post-processing apparatus according to the second embodiment, viewed from the thickness direction of a sheet.

FIG. 43A to FIG. 43C are cross-sectional views of a liquid applier taken along a line XXV-XXV of FIG. 35.

FIG. 44A to FIG. 44C are cross-sectional views of a liquid application unit of a liquid applier taken through XXVI-XXVI of FIG. 35.

FIG. 45 is a block diagram illustrating a hardware configuration of the post-processing apparatus according to the second embodiment to control the operation of the post-processing apparatus.

FIG. 46 is a flowchart of post-processing performed by the post-processing apparatus according to the second embodiment.

FIG. 47 is a diagram illustrating an overall configuration of an image forming system according to a modification.

FIG. 48A and FIG. 48B are diagrams each of which illustrates a post-processing apparatus including a controller, according to a first modification.

FIG. 49A and FIG. 49B are diagrams each of which illustrates a post-processing apparatus including a controller, according to a second modification.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to limit the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

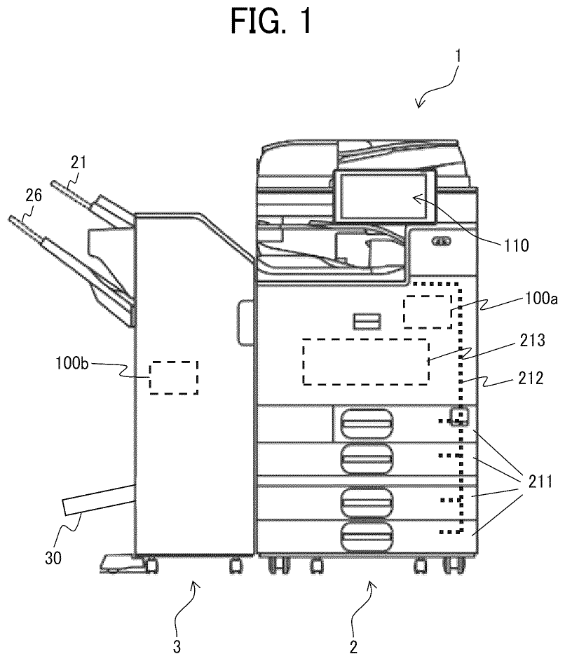

FIG. 1 is a diagram illustrating an overall configuration of the image forming system 1.

The image forming system 1 has, for example, an image forming function of forming an image on a sheet P as an example of a sheet medium and a post-processing function of performing predetermined post-processing on the sheet P on which the image has been formed. As illustrated in FIG. 1, the image forming system 1 includes an image forming apparatus 2 having the image forming function and a post-processing apparatus 3 serving as a medium processing apparatus having the post-processing function, according to an embodiment of the present disclosure. In the image forming system 1, the image forming apparatus 2 and the post-processing apparatus 3 operate in conjunction with each other.

In the present embodiment, the sheet medium to be processed in the image forming system 1 is assumed to be a sheet of paper. However, the object to be processed according to the present embodiment is not limited to a sheet of paper. For example, any type of medium can be used as long as an image can be formed on the medium according to an image forming process. Examples of the medium include a medium that can be an object of folding or binding, and the material and specification of the medium are not limited to any particular material and specification.

The image forming apparatus 2 forms an image on the sheet P and ejects the sheet P having the image to the post-processing apparatus 3. The image forming apparatus 2 includes an accommodation tray 211 that accommodates sheets P, a conveyor 212 that conveys a sheet P from the accommodation tray 211, and an image forming device 213 that forms an image on the sheet P conveyed by the conveyor 212.

The image forming device 213 may be an inkjet system that forms an image using an inkjet system or an electrophotographic system that forms an image with toner. The image forming apparatus 2 also includes a controller 100a that controls various kinds of operations of the conveyor 212 and the image forming device 213. Since the image forming apparatus 2 of FIG. 1 has a known configuration, a detailed description of the configuration and functions of the image forming apparatus 2 is omitted.

Sheets of paper are widely used as sheet media. In the following description, a sheet-shaped medium as a medium to be processed is referred to as a “sheet P.” Further, in the following description, a bundle of sheets of paper as a plurality of media is an example of a sheet bundle Pb.

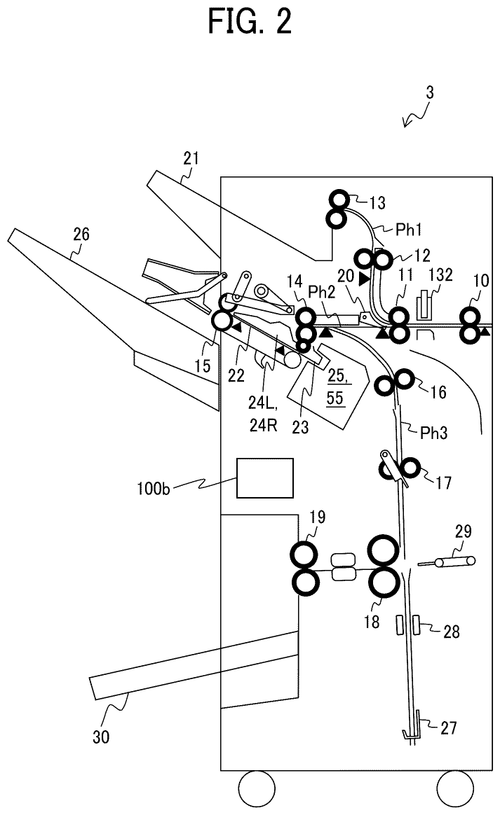

FIG. 2 is a diagram illustrating an internal structure of the post-processing apparatus 3 according to the first embodiment.

The post-processing apparatus 3 has a function that performs post-processing on the sheet P on which an image has been formed by the image forming apparatus 2.

An example of the post-processing according to the present embodiment is crimp binding that binds, without staples, a plurality of sheets P on each of which an image is formed as a bundle of sheets, which may be referred to as a sheet bundle. Another example of the post-processing according to the present embodiment is binding as a stapling that binds, with staples, a plurality of sheets P on each of which an image is formed as a bundle of sheets P (i.e., sheet bundle). A bundle of sheets P may be referred to as a sheet bundle Pb, which is an example of a medium bundle, in the following description.

In the present embodiment, how the liquid is applied when crimp binding is to be performed is described. However, liquid application performed in a stapling process is similar to the liquid application in the crimp binding. In the following description, the term binding indicates both crimping and the stapling, and is not limited to a particular binding method that adopts staples or pressure-deforming.

More specifically, in the crimp binding according to the present embodiment, pressure is applied to the binding position that corresponds to a part of a sheet bundle Pb to deform or pressure-deform the binding position and bind the sheet bundle Pb. The binding that is executed by the post-processing apparatus 3 includes edge binding and saddle binding. The edge binding is a process to bind an end or edge of the sheet bundle Pb. The saddle binding, which may be referred to as saddle stitching in the following description, is a process to bind the central portion of the sheet bundle Pb.

The post-processing apparatus 3 includes conveyance roller pairs 10 to 19 (an example of conveyors), a switching member 20, and a controller 100b (an example of a control device). The controller 100b controls the operations of, for example, the conveyance roller pairs 10 to 19 (an example of conveyors), and the switching member 20. The controller 100b will be described later in detail. The conveyance roller pairs 10 to 19 convey, inside the post-processing apparatus 3, a sheet P supplied from the image forming apparatus 2. More specifically, the conveyance roller pairs 10 to 13 convey the sheet P along a first conveyance path Ph1. The conveyance roller pairs 14 and 15 convey the sheet P along a second conveyance path Ph2. The conveyance roller pairs 16 to 19 convey the sheet P along a third conveyance path Ph3. A hole punch 132 is disposed between the conveyance roller pairs 10 and 11. The hole punch 132 performs punching on the sheet P conveyed by the conveyance roller pairs 10 and 11.

The first conveyance path Ph1 is a passage extending to a first output tray 21 from a supply port through which the sheet P is supplied from the image forming apparatus 2. The second conveyance path Ph2 is a passage branching from the first conveyance path Ph1 between the conveyance roller pairs 11 and 14 in a conveyance direction and extending to a second output tray 26 via an internal tray 22. The third conveyance path Ph3 is a passage branching from the first conveyance path Ph1 between the conveyance roller pairs 11 and 14 in the conveyance direction and extending to an output tray 30.

The switching member 20 is disposed at a branching position of the first conveyance path Ph1 and the second conveyance path Ph2. The switching member 20 can be switched between a first position and a second position. The switching member 20 in the first position guides the sheet P to be ejected to the first output tray 21 through the first conveyance path Ph1. The switching member 20 in the second position guides the sheet P conveyed through the first conveyance path Ph1 to the second conveyance path Ph2. When a trailing end of the sheet P entering the second conveyance path Ph2 passes through the conveyance roller pair 11, the conveyance roller pair 14 is rotated in reverse to guide the sheet P to the third conveyance path Ph3. The post-processing apparatus 3 further includes a plurality of sensors that detects the positions of the sheet P in the first conveyance path Ph1, the second conveyance path Ph2, and the third conveyance path Ph3. Each of the multiple sensors is indicated by a black triangle in FIG. 2.

The post-processing apparatus 3 includes the first output tray 21. The sheet P that is ejected through the first conveyance path Ph1 rests on the first output tray 21. Among the sheets P supplied from the image forming apparatus 2, the sheets P that are not bound are ejected to the first output tray 21.

The post-processing apparatus 3 further includes the internal tray 22 as a receptacle, an end fence 23, side fences 24L and 24R, an edge binder 25, a staple binder 55, and the second output tray 26. The internal tray 22, the end fence 23, the side fences 24L and 24R, the edge binder 25, and the staple binder 55 perform edge binding on the sheet bundle Pb including multiple sheets P conveyed from the second conveyance path Ph2 to the internal tray 22. Among the sheets P supplied from the image forming apparatus 2, the sheet bundle Pb subjected to the edge binding is ejected to the second output tray 26.

The edge binding in the present embodiment includes parallel binding, oblique binding, and vertical binding. The parallel binding is a process to perform binding along one side of the sheet bundle Pb parallel to the main scanning direction. The oblique binding is a process to perform binding at a corner of the sheet bundle Pb. The vertical binding is a process to perform binding at a plurality of positions spaced apart from each other in the width direction along one side of the sheet bundle Pb parallel to the conveyance direction.

In the following description, a direction in which the sheet P is conveyed from the conveyance roller pair 15 toward the end fence 23 is defined as a “conveyance direction.” In other words, the “conveyance direction” herein corresponds to a direction in which the sheet P that has been output from the image forming apparatus 2 is moved toward the second output tray 26 by, for example, the conveyance roller pair 10, is changed to move toward the end fence 23 by the conveyance roller pair 15 in a direction different from the above-described direction. The direction that is orthogonal to both the conveyance direction and a thickness direction of the sheet P is defined as a “main scanning direction” or a “width direction of the sheet P.”

The sheets P that are sequentially conveyed through the second conveyance path Ph2 are temporarily placed on the internal tray 22 as a receptacle. The end fence 23 aligns the position, in the conveyance direction, of the sheet P or the sheet bundle Pb placed on the internal tray 22. The side fences 24L and 24R align the position, in the main scanning direction, of the sheet P or the sheet bundle Pb placed on the internal tray 22. The edge binder 25 and the staple binder 55 bind an end of the sheet bundle Pb aligned by the end fence 23 and the side fences 24L and 24R. Then, the conveyance roller pair 15 ejects the sheet bundle Pb subjected to the edge binding to the second output tray 26.

The post-processing apparatus 3 further includes an end fence 27, a saddle binder 28, a sheet folding blade 29, and the output tray 30. The end fence 27, the saddle binder 28, and the sheet folding blade 29 perform saddle stitching or saddle binding on a sheet bundle Pb foamed of the sheets P that are conveyed through the third conveyance path Ph3. Among the sheets P supplied from the image forming apparatus 2, the sheet bundle Pb subjected to the saddle binding is ejected to the output tray 30.

The end fence 27 aligns the positions of the sheets P that are sequentially conveyed through the third conveyance path Ph3, in a conveyance direction in which the sheets P are conveyed. The end fence 27 can move between a binding position where the end fence 27 causes the center of the sheet bundle Pb to face the saddle binder 28 and a folding position where the end fence 27 causes the center of the sheet bundle Pb to face the sheet folding blade 29. The saddle binder 28 binds the center of the sheet bundle Pb aligned by the end fence 27 at the binding position. The sheet folding blade 29 folds, in half, the sheet bundle Pb placed on the end fence 27 at the folding position and causes the conveyance roller pair 18 to nip the sheet bundle Pb. The conveyance roller pairs 18 and 19 eject the sheet bundle Pb subjected to the saddle binding to the output tray 30.

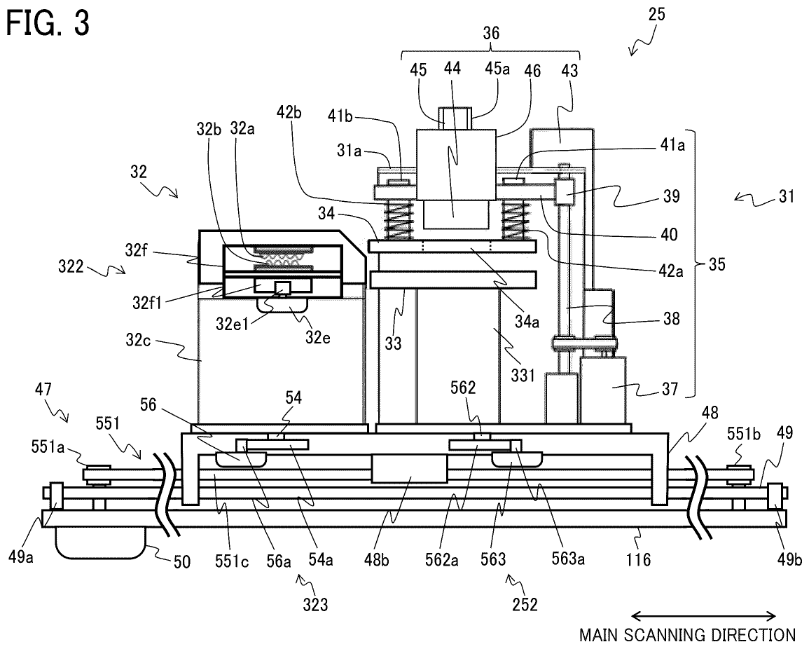

FIG. 3 is a schematic diagram illustrating an upstream side of the edge binder 25 viewed in the conveyance direction. The edge binder 25 performs liquid application and crimping illustrated in FIG. 2.

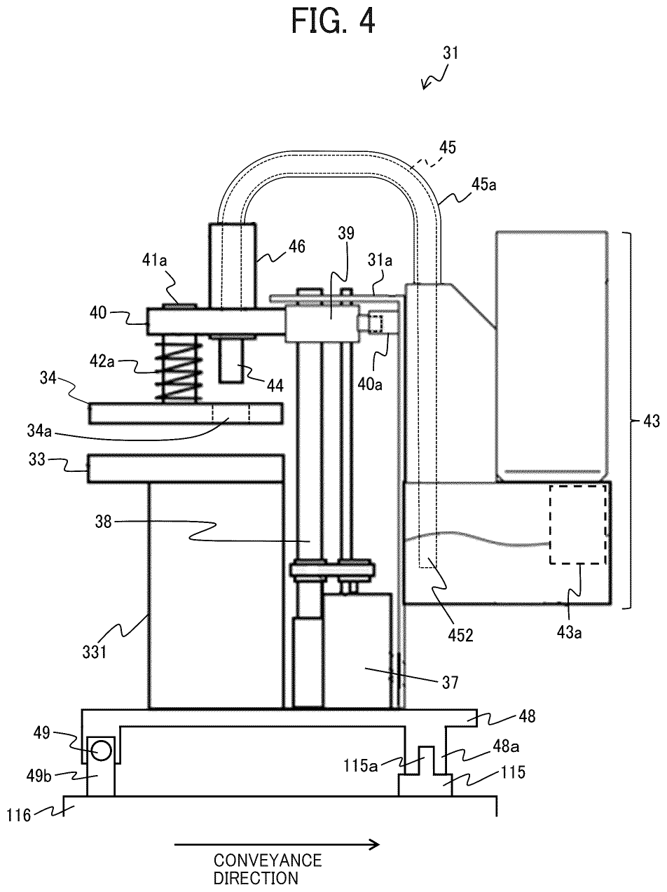

FIG. 4 is a schematic diagram of a liquid applier 31 of the edge binder 25 viewed in the main scanning direction.

As illustrated in FIG. 3 and FIG. 4, the edge binder 25 includes a liquid applier 31 that applies liquid to the sheets P, and a crimper 32 that is an example of a postprocessor and performs crimping binding on the sheet bundle Pb. The liquid applier 31 and the crimper 32 are disposed adjacent to each other in the main scanning direction downstream from the internal tray 22 in the conveyance direction.

As illustrated in FIG. 4, the liquid applier 31 applies the liquid stored in the first liquid storage tank 43 to the sheet P or the sheet bundle Pb placed on the internal tray 22. In the following description, applying liquid to a sheet P or a sheet bundle Pb by the liquid applier 31 and the operation of the liquid applier 31 when applying liquid are referred to as “liquid application.” The liquid applying operation of the liquid applier 31 that is accompanied by the control process may be referred to as liquid application in the following description.

More specifically, the liquid that is stored in the first liquid storage tank 43 as liquid for the “liquid application” includes, as a main component, the liquid state of a compound of hydrogen and oxygen compound represented by the chemical formula H2O. The temperature condition is not limited, and the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid may include an additive in addition to the main component. The liquid may include residual chlorine used as tap water. Preferably, for example, the liquid may include, as an additive, a colorant, a penetrant, a pH adjuster, a preservative such as phenoxyethanol, a drying inhibitor such as glycerin, or a combination thereof. Furthermore, because water is used as a component of ink used for inkjet printers or ink used for water-based pens, such water or ink may be used for the “liquid application”.

The water is not limited to the specific examples described above. The water may be water in a broad sense such as hypochlorous acid water or an ethanol aqueous solution diluted for disinfection. However, tap water may be used simply to enhance the binding strength after the binding because tap water is easy to obtain and store. A liquid including water as a main component as exemplified above can enhance the binding strength of the sheet bundle Pb, as compared with a liquid of which the main component is not water.

As illustrated in FIG. 3 and FIG. 4, the liquid applier 31 can be moved in the main scanning direction together with the crimper 32 by the driving force transmitted from the edge-binder movement motor 50. The liquid applier 31 includes a lower pressure plate 33 serving as a placement table for the sheet P or the sheet bundle Pb, an upper pressure plate 34, a liquid-applier movement assembly 35, and a liquid application assembly 36. The components of the liquid applier 31, which include the lower pressure plate 33, the upper pressure plate 34, the liquid-applier movement assembly 35, the liquid application assembly 36, and the liquid-applier movement motor 37, are held by the liquid application frame 31a and the base 48.

As illustrated in FIG. 3, the liquid applier 31 is provided with a liquid-applier rotation assembly 252. The liquid-applier rotation assembly 252 includes a liquid-applier pivot motor 563, an output gear 563a, and a drive transmission gear 562a, which will be described later in detail. A liquid applier shaft 562 provided with a drive transmission gear 562a is fixed to a bottom face of the liquid application frame 31a that holds the components of the liquid applier 31. The liquid applier shaft 562 and the drive transmission gear 562a are held by the base 48 on which the liquid application frame 31a is disposed, so as to be rotatable in both forward and reverse directions.

The drive transmission gear 562a meshes with an output gear 563a of a liquid-applier pivot motor 563. The liquid applier 31 can be rotated in both forward and reverse directions about the liquid applier shaft 562 on the base 48 by a driving force transmitted from the liquid-applier pivot motor 563 to the liquid applier shaft 562 via the output gear 563a and the drive transmission gear 562a.

The lower pressure plate 33 and the upper pressure plate 34 are disposed downstream from the internal tray 22 in the conveyance direction. The sheets P or the sheet bundle Pb that is placed on the internal tray 22 is also placed on the lower pressure plate 33. The lower pressure plate 33 is disposed on a lower pressure plate holder 331. The upper pressure plate 34 is movable in the thickness direction of the sheet P or the sheet bundle Pb at a position where the upper pressure plate 34 faces the sheet P or the sheet bundle Pb placed on the internal tray 22.

In other words, the lower pressure plate 33 and the upper pressure plate 34 are disposed to face each other in the thickness direction of the sheet P or the sheet bundle Pb with the sheet P or the sheet bundle Pb placed on the internal tray 22 and interposed between the lower pressure plate 33 and the upper pressure plate 34. In the following description, the thickness direction of the sheet P or the sheet bundle Pb may be referred to simply as “thickness direction.” Further, the upper pressure plate 34 is provided with a through hole 34a passing through the upper pressure plate 34 in the thickness direction at a position opposite to the liquid application member 44 held via the joint 46 attached to the base plate 40. The liquid application member 44 is one end of a liquid supply member 45, which serves as a liquid absorber and will be described later in detail, and corresponds to a tip of the liquid supply member 45.

The liquid-applier movement assembly 35 moves the upper pressure plate 34, the base plate 40, a joint 46, and the liquid application member 44 in the thickness direction of the sheet P or the sheet bundle Pb. The liquid-applier movement assembly 35 moves the upper pressure plate 34, the base plate 40, the joint 46, and the liquid application member 44 in conjunction with each other with a single liquid-applier movement motor 37. The liquid-applier movement assembly 35 includes, for example, the liquid-applier movement motor 37, a trapezoidal screw 38, a nut 39, the base plate 40, columns 41a and 41b, and coil springs 42a and 42b.

The liquid-applier movement motor 37 generates driving force to move the upper pressure plate 34, the base plate 40, the joint 46, and the liquid application member 44. The trapezoidal screw 38 extends in the thickness direction of the sheet P or the sheet bundle Pb and is provided with the liquid application frame 31a such that the trapezoidal screw 38 is rotatable in both forward and reverse directions. The trapezoidal screw 38 is coupled to an output shaft of the liquid-applier movement motor 37 via, for example, a pulley and a belt. The nut 39 is screwed to the trapezoidal screw 38. The trapezoidal screw 38 is rotated in both forward and reverse directions by the driving force transmitted from the liquid-applier movement motor 37. The rotation of the trapezoidal screw 38 causes the nut 39 to reciprocate on the trapezoidal screw 38.

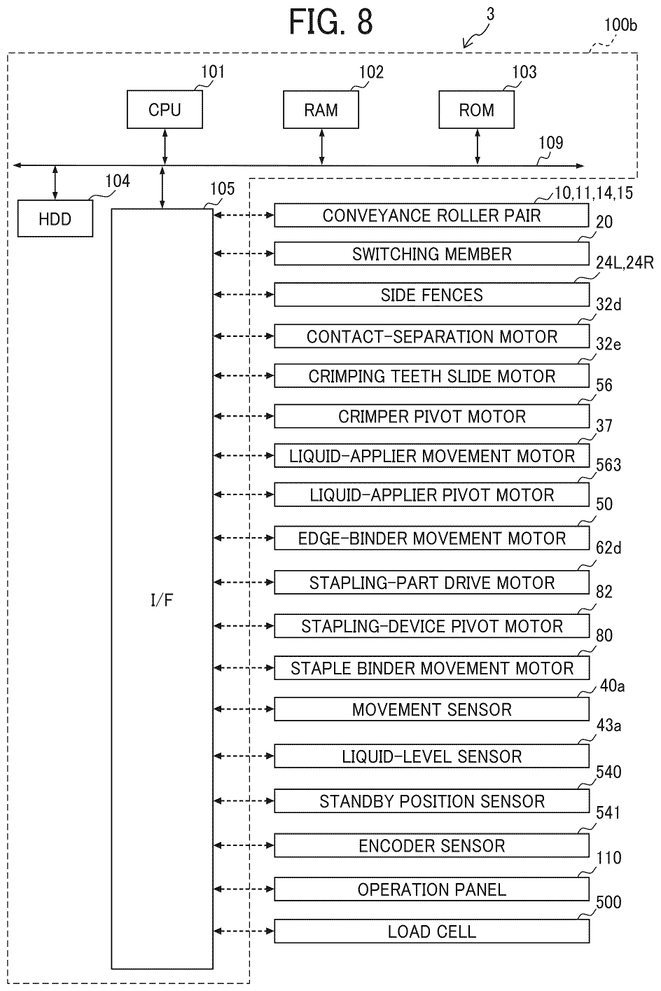

The base plate 40 is positioned apart from the upper pressure plate 34. The base plate 40 holds the liquid application member 44 with the tip of the liquid application member 44 protruding from the base plate 40 toward the upper pressure plate 34. The base plate 40 is coupled to the trapezoidal screw 38 via the nut 39 such that base plate 40 can reciprocate along the trapezoidal screw 38 as the trapezoidal screw 38 rotates in both forward and reverse directions. The position of the base plate 40 in the vertical direction is detected by a movement sensor 40a (see FIG. 8).

The columns 41a and 41b project from the base plate 40 toward the upper pressure plate 34 around the tip of the liquid application member 44. The columns 41a and 41b can be moved relative to the base plate 40 in the thickness direction. The columns 41a and 41b hold the upper pressure plate 34 with the respective ends closer to the lower pressure plate 33 than the other ends of the columns 41a and 41b. The other ends of the columns 41a and 41b opposite the ends closer to the lower pressure plate 33 are provided with stoppers that prevent the columns 41a and 41b from being removed from the base plate 40.

The coil springs 42a and 42b are fitted around the columns 41a and 41b, respectively, between the base plate 40 and the upper pressure plate 34. The coil springs 42a and 42b bias the upper pressure plate 34 and the columns 41a and 41b toward the lower pressure plate 33 with respect to the base plate 40.

The liquid application assembly 36 applies liquid to the sheet P or the sheet bundle Pb placed on the internal tray 22. Specifically, the liquid application assembly 36 brings the liquid application member 44 into contact with the sheet P or the sheet bundle Pb to apply the liquid to at least one sheet P of the sheet bundle Pb.

The liquid application assembly 36 includes the liquid application member 44, the liquid supply member 45, the first liquid storage tank 43, and the joint 46. The first liquid storage tank 43 stores the liquid to be supplied to the sheet P or the sheet bundle Pb. The liquid stored in the first liquid storage tank 43 is detected by a liquid level sensor 43a serving as a first liquid detector.

The liquid application member 44 applies the liquid stored in the first liquid storage tank 43 to the sheet P or the sheet bundle Pb. The liquid application member 44 is held by the base plate 40 with the tip of the liquid application member 44 facing the upper pressure plate 34.

Further, the liquid application member 44 includes a material having a relatively high liquid absorption rate. For example, the liquid application member 44 includes an open-cell foam that can contain liquid. The liquid application member 44 is not limited to a particular kind as long as the liquid application member 44 is made of a material having a property of absorbing and holding the liquid and has a property of being crushable in accordance with a pressing force applied when the liquid application member 44 is in contact with the sheet P. The pressing force corresponds to an amount of movement of the liquid application member 44 to the sheet P (or the sheet bundle Pb). For example, the liquid application member 451 may be a foam material such as a sponge or a fiber material that can absorb liquid by capillary action.

The liquid supply member 45, which serves as a liquid absorber, is a long member having an immersion portion 452 at a base end immersed in the liquid stored in the first liquid storage tank 43 and a tip coupled to the liquid application member 44. In a similar manner to the liquid application member 44, for example, the liquid supply member 45 is made of a material having a relatively high liquid absorption rate. As a result, the liquid absorbed from the immersion portion 452 of the liquid supply member 45 is supplied to the liquid application member 44 by the capillary action. In other words, the liquid stored in the first liquid storage tank 43 is sucked up from the immersion portion 452 of the liquid supply member 45, and the sucked liquid is supplied to the liquid application member 44 that is coupled to the tip via the liquid supply member 45.

As described above, the liquid sucked up from the immersion portion 452 of the liquid supply member 45 is supplied to the liquid application member 44 through the liquid supply member 45, and the liquid application member 44 contacts the upper face of an uppermost sheet of the sheets P or the sheet bundle Pb to apply the liquid.

Although the case where the liquid supply member 45 and the liquid application member 44 are separate bodies has been described above, the liquid supply member 45 and the liquid application member 44 may be integrally formed of a material having the same properties (e.g., a material having a high liquid absorption rate). In other words, the liquid application member 44 may be part of the liquid supply member 45. In such a case, liquid can be supplied from the liquid supply member 45 to the liquid application member 44 more smoothly by the capillary action.

A protector 45a is an elongated cylindrical body (e.g., a tube) that is fitted around the liquid supply member 45. Such a configuration prevents the liquid absorbed by the liquid supply member 45 from leaking or evaporating. Each of the liquid supply member 45 and the protector 45a is made of a flexible material. The joint 46 holds the liquid application member 44 and is arranged on the base plate 40. Accordingly, even when the liquid application member 44 is moved by the liquid-applier movement assembly 35 in a direction orthogonal to the conveyance direction and the main scanning direction, the liquid application member 44 keeps projecting from the base plate 40 toward the upper pressure plate 34 with the tip of the liquid application member 44 facing the upper pressure plate 34.

In the liquid application process, the controller 100 controls the amount of movement (pressing amount) of the liquid application member 44 to the sheet P or the sheet bundle Pb by controlling the amount of driving force of the liquid-applier movement motor 37. By controlling the amount of movement of the liquid application member 44 relative to the sheet P or the sheet bundle Pb, the size of a contact area where the liquid application member 44 contacts the sheet P or the sheet bundle Pb is adjusted, or the length of time that the liquid application member 44 contacts the sheet P or the sheet bundle Pb, which may be referred to as contact time in the following description, is adjusted. With this adjustment, the amount of liquid applied to the sheet P or the sheet bundle Pb and the spread of the liquid in the liquid application process can be adjusted.

As illustrated in FIG. 3, the crimper 32 as a post-processing device presses and deforms at least a portion (liquid application position) of the sheet bundle Pb, to which liquid has been applied by the liquid applier 31, by serrated upper crimping teeth 32a and lower crimping teeth 32b, and crimps the sheets P of the portion to bind the sheet bundle Pb. In short, the crimper 32 binds the sheet bundle Pb without staples. The components of the crimper 32 such as the upper crimping teeth 32a and the lower crimping teeth 32b are disposed on a crimper frame 32c. In the following description, such a way of pressing and deforming a given position on the sheet bundle Pb by the crimper 32 to bind the sheet bundle Pb may be referred to simply as crimping. The crimping and binding operation of the crimper 32 that involves control processes may be referred to as crimping in the following description.

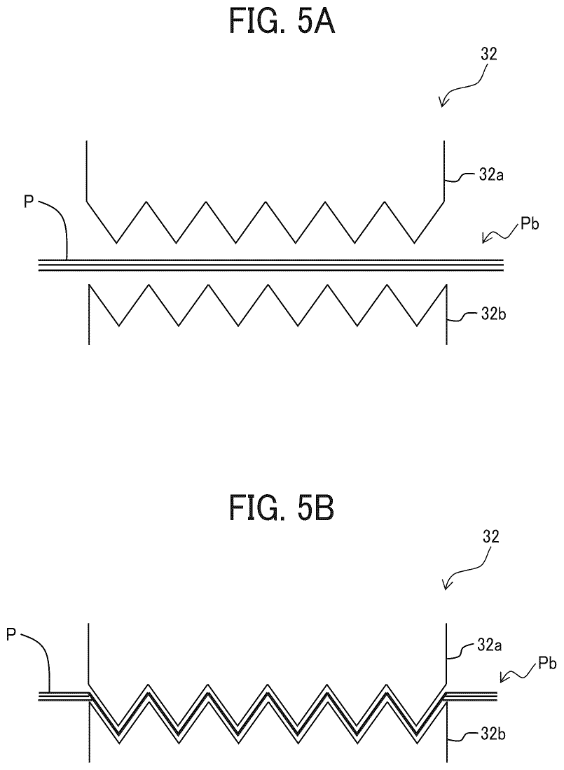

FIG. 5A and FIG. 5B are schematic diagrams illustrating a configuration of the crimper 32.

As illustrated in FIG. 5A and FIG. 5B, the crimper 32 includes the upper crimping teeth 32a and the lower crimping teeth 32b. The upper crimping teeth 32a and the lower crimping teeth 32b are disposed to face each other in the thickness direction of the sheet bundle Pb to sandwich the sheet bundle Pb placed on the internal tray 22. The upper crimping teeth 32a and the lower crimping teeth 32b have respective serrate faces facing each other. The serrate face of each of the upper crimping teeth 32a and the lower crimping teeth 32b includes concave portions and convex portions alternately formed. The concave portions and the convex portions of the upper crimping teeth 32a are shifted from those of the lower crimping teeth 32b such that the upper crimping teeth 32a mesh with the lower crimping teeth 32b. The upper crimping teeth 32a and the lower crimping teeth 32b contact and detach from each other by the driving force of a contact-separation motor 32d (see FIG. 8).

In the process of supplying the sheets P of the sheet bundle Pb to the internal tray 22, the upper crimping teeth 32a and the lower crimping teeth 32b are separated from each other as illustrated in FIG. 5A. When all the sheets P of the sheet bundle Pb are placed on the internal tray 22, the upper crimping teeth 32a and the lower crimping teeth 32b are engaged with each other as illustrated in FIG. 5B by the driving force of the contact-separation motor 32d to press and deform the sheet bundle Pb in the thickness direction. As a result, the sheet bundle Pb that has been placed on the internal tray 22 is crimped and bound. The sheet bundle Pb thus crimped and bound is ejected to the second output tray 26 by the conveyance roller pair 15.

The configuration of the crimper 32 as a crimping assembly is not limited to the configuration of a moving assembly exemplified in the present embodiment, and may be any other suitable structure in which the upper crimping teeth 32a and the lower crimping teeth 32b of the crimping assembly engage with each other. For example, the crimping assembly may bring the upper crimping teeth 32a and the lower crimping teeth 32b into contact with each other and separate the upper crimping teeth 32a and the lower crimping teeth 32b from each other with a link mechanism and a driving source that simply rotates in the forward direction or rotates in both the forward and reverse directions. Alternatively, the crimping assembly may employ a linear motion system to linearly bring the upper crimping teeth 32a and the lower crimping teeth 32b into contact with each other and separate the upper crimping teeth 32a and the lower crimping teeth 32b from each other with a screw assembly that converts the forward and backward rotational motions of a driving source into linear reciprocating motion.

As illustrated in FIG. 3, the crimper 32 includes a crimping-teeth sliding assembly 322. The crimping-teeth sliding assembly 322 includes a crimping-teeth slide motor 32e, a pinion gear 32e1, a rack 32f1, and a crimping-teeth frame 32f, which will be described later in detail. The upper crimping teeth 32a and the lower crimping teeth 32b are arranged on the crimping-teeth frame 32f. As will be described later in detail, the crimping-teeth frame 32f has the pinion gear 32e1 and the rack 32f1 that engage with each other and are formed as a single integrated unit. The crimping-teeth frame 32f is attached to the crimper frame 32c so as to be movable in the main scanning direction. The crimping-teeth slide motor 32e generates a driving force to move the crimping-teeth frame 32f in the main scanning direction. The pinion gear 32e1 is attached to the output shaft of the crimping-teeth slide motor 32e. As the crimping-teeth slide motor 32e is driven to rotate in both the forward and reverse directions, the pinion gear 32e1 rotates in both the forward and reverse directions. As the pinion gear 32e1 rotates in both the forward and reverse directions, the rack 32f1 that engages with the pinion gear 32e1 reciprocates in the main scanning direction relative to the crimper frame 32c. As a result, the crimping-teeth frame 32f that is integrally arranged with the rack 32f1 also reciprocates in the main scanning direction relative to the crimper frame 32c. In other words, the upper crimping teeth 32a and the lower crimping teeth 32b provided for the crimping-teeth frame 32f can move in the main scanning direction as the crimping-teeth slide motor 32e is driven to rotate in both the forward and reverse directions. Accordingly, the upper crimping teeth 32a and the lower crimping teeth 32b can perform the binding operation several times with their positions moved in the main scanning direction relative to the sheet bundle Pb.

It is assumed in the present embodiment that the amount of movement of the upper crimping teeth 32a and the lower crimping teeth 32b, which make up the crimping assembly, in the main scanning direction is equivalent to the length of the crimping mark formed by the binding operation of the upper crimping teeth 32a and the lower crimping teeth 32b, and the crimping and binding operation is performed several times before and after the movement in the main scanning direction. In other words, when the length of the crimping mark formed by the binding operation of the upper crimping teeth 32a and the lower crimping teeth 32b is 10 millimeters (mm), it is assumed that the amount of movement in the main scanning direction is also 10 mm, and the length of the crimping mark can be made 20 mm by adding up the crimping operation for the first time before the movement in the main scanning direction and the crimping operation for the second time after the movement in the main scanning direction. Accordingly, the binding force of the crimper 32 increases about twofold. As illustrated in FIG. 3, the crimper 32 includes a crimper rotation assembly 323 that serves as a postprocessor rotation assembly. The crimper rotation assembly 323 includes a crimper pivot motor 56, an output gear 56a, and a drive transmission gear 54a, which will be described later in detail. The crimper shaft 54 including a drive transmission gear 54a is fixed to a bottom face of the crimper frame 32c that holds the components of the crimper 32′.

The crimper shaft 54 and the drive transmission gear 54a are held by a base 48 on which the crimper frame 32c is disposed, so as to be rotatable in both forward and reverse directions. The drive transmission gear 54a meshes with an output gear 56a of a crimper pivot motor 56. The crimper 32 can be rotated in both forward and reverse directions about the crimper shaft 54 on the base 48 by a driving force transmitted from the crimper pivot motor 56 to the crimper shaft 54 via the output gear 56a and the drive transmission gear 54a.

As illustrated in FIG. 3, the edge binder 25 includes an edge-binder movement assembly 47. The edge-binder movement assembly 47 moves the edge binder 25, i.e., the liquid applier 31 and the crimper 32, in the main scanning direction along a downstream end in the conveyance direction of the sheet P placed on the internal tray 22. The edge-binder movement assembly 47 includes, for example, the base 48, a guide shaft 49, the edge-binder movement motor 50, and a driving force transmission assembly 551 that transmits the driving force of the edge-binder movement motor 50 to the base 48, and a standby position sensor 540 (see FIG. 8).

The liquid applier 31 and the crimper 32 are attached to the base 48 such that the liquid applier 31 and the crimper 32 are adjacent to each other in the main scanning direction. As illustrated in FIG. 4, the guide shaft 49 is held by multiple guide shaft brackets 49a disposed in the main scanning direction at a position on the upstream side of a binding assembly base 116 in the conveyance direction of the sheet P. As illustrated in FIG. 3, the guide shaft 49 extends in the main scanning direction on the binding assembly base 116. The guide rail 115 is disposed in the main scanning direction on the downstream side of the binding assembly base 116 in the conveyance direction of the sheet P. As illustrated in FIG. 4, the guide rail 115 includes a fitting target portion 115a that fits to a fitting portion 48a of the base 48 in the main scanning direction. In other words, the base 48 is movably held by the guide shaft 49 and the guide rail 115 in the main scanning direction on the binding assembly base 116.

The edge-binder movement motor 50 generates a driving force to move the edge binder 25. The driving force transmission assembly 551 transmits the driving force of the edge-binder movement motor 50 to the base 48 via pulleys 551a and 551b, a timing belt 551c, and a fastening portion 48b that fastens the base 48 and the timing belt 551c. As a result, the liquid applier 31 and the crimper 32 integrated by the base 48 move in the main scanning direction along the guide shaft 49.

The edge-binder movement motor 50 is, for example, a servo motor that can stop the edge binder 25 at a desired position without returning the edge binder 25 to a starting point such as a standby home position (HP), which will be described later in detail, every time the edge binder 25 is moved. The target position of the edge binder 25 is a position at which the crimper 32 binds the sheet bundle Pb.

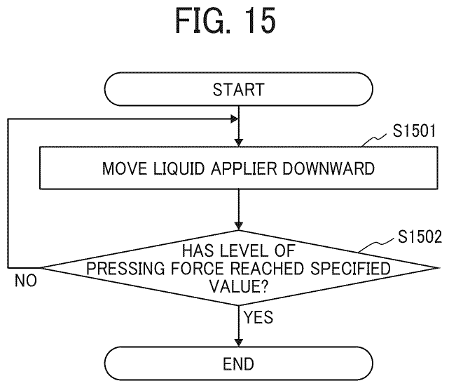

The post-processing apparatus 3 further includes a standby position sensor 540 and an encoder sensor 541. The standby position sensor 540 is, for example, a light-shielding optical sensor (see FIG. 8) to detect that the edge binder 25 has reached a standby home position (HP) (see FIG. 15A). The encoder sensor 541 (see FIG. 8) is attached to an output shaft of the edge-binder movement motor 50. The controller 100b, which is described below, detects that the edge binder 25 has reached the standby position HP, based on a detection result of the standby position sensor 540. As will be described later in detail, the controller 100b counts pulse signals output from the encoder sensor 541 to ascertain the current position of the edge binder 25 moved from the standby position HP.

However, a specific method of stopping the edge binder 25 at the target position without returning the edge binder 25 to the origin position is not limited to the above-described example. As another example, the post-processing apparatus 3 may include a sensor that detects the arrival of the edge binder 25 at a given target position determined in advance.

In other words, the controller 100b causes the edge-binder movement assembly 47 to move the edge binder 25 by the shortest distance between the position at which the liquid applier 31 faces the first liquid application position B1 and the position at which the liquid applier 31 faces the second liquid application position B2 without passing through the standby position HP. The edge-binder movement assembly 47 can also move the edge binder 25 by the shortest distance between the position at which the crimper 32 faces the first binding position B1 and the position at which the crimper 32 faces the second binding position B2 without passing through the standby position HP. Further, the controller 100b causes the edge-binder movement assembly 47 to move the edge binder 25 by the shortest distance between the position at which the liquid applier 31 faces the first liquid application position B1 (or the second liquid application position B2) and the position at which the crimper 32 faces the first binding position B1 (or the second binding position B2) without passing through the standby position HP.

In the above description, the edge binder 25 moves along the guide shaft 49 with the crimper 32 and the liquid applier 31 integrated. However, no limitation is intended thereby. For example, the crimper 32 and the liquid applier 31 may have a configuration of moving separately from each other.

The position on a sheet P or a sheet bundle Pb to which liquid is applied by the liquid applier 31, which may be referred to as liquid application position in the following description, corresponds to the binding position on the sheet bundle Pb to be crimped by the crimper 32. For this reason, as described above, the first liquid application position and the first binding position share reference sign B1 and the second liquid application position and the second binding position share reference sign B2.

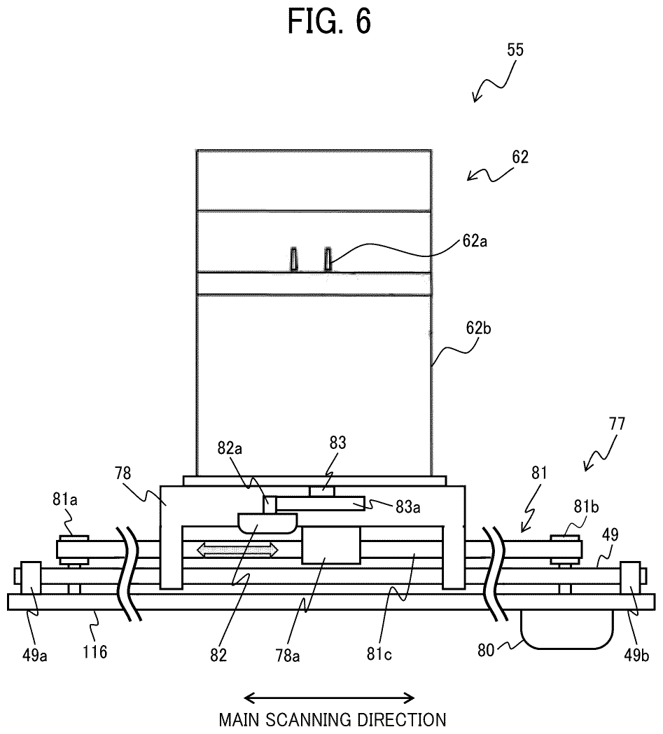

FIG. 6 is a schematic view of the staple binder 55 as viewed from the upstream side in the conveyance direction.

The staple binder 55 includes a stapler 62 that binds the sheet bundle Pb with staples. The stapler 62 is disposed downstream from the internal tray 22 in the conveyance direction of the sheet P and spaced apart from the edge binder 25 in the main scanning direction.

The stapler 62 serving as a post-processing device has a configuration of performing so-called “staple binding” to bind a sheet bundle Pb with a staple(s). More specifically, the stapler 62 includes a stapling-part drive motor 62d (see FIG. 8) that drives the stapling part 62a. The stapling part 62a causes the staple loaded in the stapling part 62a to penetrate the sheet bundle Pb by the driving force of the stapling-part drive motor 62d. By so doing, the sheet bundle Pb is bound. The configuration of the stapler 62 is already known, and thus detailed description thereof will be omitted.

As illustrated in FIG. 6, the staple binder 55 includes a staple-binder movement assembly 77. The staple-binder movement assembly 77 moves the staple binder 55 in the main scanning direction along a downstream end in the conveyance direction of the sheet P or the sheet bundle Pb placed on the internal tray 22. The staple-binder movement assembly 77 includes, for example, a base 78, the guide shaft 49, a staple-binder movement motor 80, and a driving force transmission assembly 81. The driving force transmission assembly 81 transmits a driving force of the staple-binder movement motor 80 to the base 78 via pulleys 81a and 81b, a timing belt 81c, and a fastening portion 78a that fastens the base 78 and the timing belt 81c. A stapler shaft 83 including a drive transmission gear 83a is fixed to a bottom face of a stapling frame 62b that holds the components of the stapler 62.

The stapler shaft 83 and the drive transmission gear 83a are held by the base 78 on which the stapling frame 62b is disposed, so as to be rotatable in both forward and reverse directions. The drive transmission gear 83a meshes with an output gear 82a of a stapler pivot motor 82. The stapler 62 is rotatable in both forward and reverse directions about the stapler shaft 83 on the base 78 by a driving force transmitted from the stapler pivot motor 82 to the stapler shaft 83 via the output gear 82a and the drive transmission gear 83a.

The edge binder 25 and the staple binder 55 are supported by the common guide shaft 49. In other words, the edge-binder movement assembly 47 and the staple-binder movement assembly 77 move the edge binder 25 and the staple binder 55 in the main scanning direction along the common guide shaft 49. The edge-binder movement assembly 47 and the staple-binder movement assembly 77 can independently move the edge binder 25 and the staple binder 55.

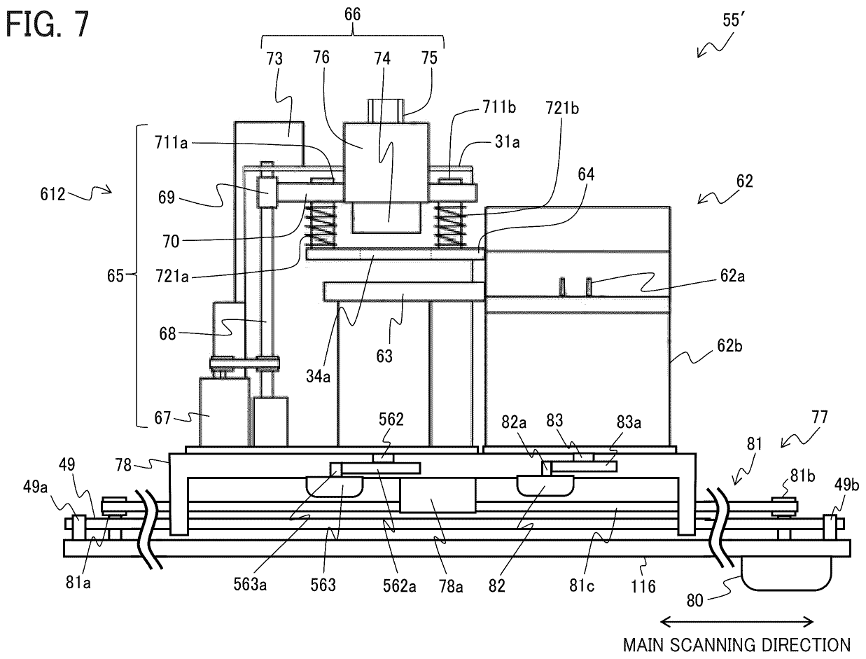

FIG. 7 illustrates a staple binder 55′ as a modification of the staple binder 55. More specifically, FIG. 7 is a schematic view of the staple binder 55′ as viewed from the upstream side in the conveyance direction.

The staple binder 55′ is different from the staple binder 55 in that the staple binder 55′ includes a second liquid applier 612 in addition to the stapler 62. As illustrated in FIG. 7, the staple binder 55′ includes the second liquid applier 612 and the stapler 62. The second liquid applier 612 and the stapler 62 are disposed adjacent to each other in the main scanning direction on the downstream side of the internal tray 22 in the conveyance direction.

The second liquid applier 612 applies the liquid stored in a second liquid storage tank 73 to the sheet P or the sheet bundle Pb placed on the internal tray 22. A given area including a position to which the liquid is applied on the sheet P or the sheet bundle Pb by the second liquid applier 612 corresponds to a binding position to be stapled by the stapler 62. As illustrated in FIG. 7, the second liquid applier 612 includes a second lower pressure plate 63, a second upper pressure plate 64 having the through hole 34a, a second liquid-applier movement assembly 65, and a second liquid application assembly 66.

The second liquid-applier movement assembly 65 includes, for example, a second liquid-applier movement motor 67, a second trapezoidal screw 68, a second nut 69, a second base plate 70, second columns 711a and 711b, and second coil springs 721a and 721b. The second liquid application assembly 66 includes the second liquid storage tank 73, a second liquid application member 74, a second liquid supply portion 75, and a second joint 76.

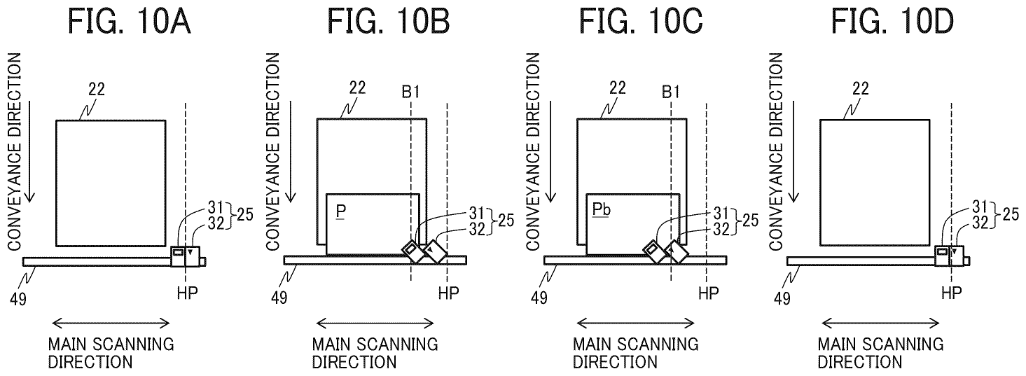

As the second liquid application assembly 66 and the liquid application assembly 36 of the liquid applier 31 described above with reference to FIG. 3 and FIG. 4 have configurations in common, overlapping descriptions are omitted where appropriate. As the configuration of the stapler 62 illustrated in FIG. 10 is equivalent to the configuration of the stapler 62 illustrated in FIG. 6, a detailed description thereof is omitted. As the second liquid applier 612 and the liquid applier 31 described above with reference to FIG. 3 have common pivot mechanisms, overlapping descriptions are omitted where appropriate. The pivot mechanism of the second liquid applier 612 includes a liquid-applier pivot motor 563, an output gear 563a, a drive transmission gear 562a, and a liquid applier shaft 562.

In the binding, the staple binder 55′ that is illustrated in FIG. 7 performs the liquid application process on the sheet P to loosen and soften the binding position, allowing the staple to easily pass through the sheet bundle Pb. As a result, the number of sheets to be bound per sheet bundle Pb can be increased as compared with a case where the stapling process is performed without performing the liquid application.

FIG. 8 is a block diagram illustrating a hardware configuration of the post-processing apparatus 3 according to the first embodiment, which is used to perform control processes in the post-processing apparatus 3.

As illustrated in FIG. 8, the post-processing apparatus 3 includes a central processing unit (CPU) 101, a random-access memory (RAM) 102, a read-only memory (ROM) 103, a hard disk drive (HDD) 104, and an interface (interface) 105 that are connected to each other through a common bus 109.

The CPU 101 is an arithmetic device and controls the overall operation of the post-processing apparatus 3. The RAM 102 is a volatile storage medium that allows high speed reading and writing of data, and is used as a working area when the CPU 101 processes information. The ROM 103 is a read-only non-volatile storage medium, and stores programs such as firmware. The HDD 104 is a nonvolatile data readable/writable memory and has a relatively large storage capacity. The HDD 104 stores, for example, an operating system (OS), various kinds of control programs, and application programs.

By an arithmetic function of the CPU 101, the post-processing apparatus 3 processes, for example, a control program stored in the ROM 103 and an information processing program (application program) loaded into the RAM 102 from a storage medium such as the HDD 104. Such processing configures a software controller including various functional modules of the post-processing apparatus 3. The software controller thus configured cooperates with hardware resources of the post-processing apparatus 3 to construct functional blocks that implement functions of the post-processing apparatus 3. In other words, the CPU 101, the RAM 102, the ROM 103, the HDD 104, and the interface 105 make up at least part of a controller 100b, which is an example of a control device, to control the operation of the post-processing apparatus 3.

The interface 105 is an interface circuit that connects the conveyance roller pairs 10, 11, 14, and 15, the switching member 20, the side fences 24L and 24R, the contact-separation motor 32d, the crimping-teeth slide motor 32e, the crimper pivot motor 56, the liquid-applier movement motor 37, the liquid-applier pivot motor 563, the edge-binder movement motor 50, the stapling-part drive motor 62d, the stapler pivot motor 82, the staple-binder movement motor 80, the movement sensor 40a, the liquid level sensor 43a, the standby position sensor 540, the encoder sensor 541, an operation panel 110, and a load cell 500 to the common bus 109.

The controller 100b controls, via the interface 105, the operations of the conveyance roller pairs 10, 11, 14, and 15, the switching member 20, the side fences 24L and 24R, the contact-separation motor 32d, the crimping-teeth slide motor 32e, the crimper pivot motor 56, the liquid-applier movement motor 37, the liquid-applier pivot motor 563, the edge-binder movement motor 50, the stapling-part drive motor 62d, the stapler pivot motor 82, and the staple-binder movement motor 80. The controller 100b acquires detection results from the movement sensor 40a, the liquid level sensor 43a, the standby position sensor 540, and the encoder sensor 541, and the load cell 500. Although FIG. 8 illustrates only the components related to the edge binder 25 and the staple binder 55 that perform the edge binding, the components related to the saddle binder 28 that performs the saddle binding are also controlled by the controller 100b.

As illustrated in FIG. 1, the image forming apparatus 2 includes the operation panel 110. The operation panel 110 includes an operation section that receives instructions input by an operator and a display (which is an example of a notifier) that notifies the operator of information. The operation section includes, for example, hard keys and a touch screen overlaid on the display. The operation panel 110 acquires information from the user through the operation device and provides information to the user through the display. A specific example of the notifier is not limited to the display and may be a light-emitting diode (LED) lamp or a loudspeaker. The post-processing apparatus 3 may include an operation panel 110 similar to the above-described operation panel 110 of the image forming apparatus 2.

As described above, the post-processing apparatus 3 includes the edge binder 25 that can perform post-processing such as crimp binding and stapling after the liquid is applied. When the number of sheets P that makes up the sheet bundle Pb is small, the edge binder 25 may perform crimping with no liquid application (i.e., crimp binding using the crimper 32 only) in a similar manner to the crimp binding in the related art.

In the edge binder 25, the liquid applier 31 and the crimper 32 can be moved in the main scanning direction by the crimping-teeth sliding assembly 322 and/or the edge-binder movement assembly 47. Due to such a configuration, the liquid application position of the liquid applier 31 and/or the binding position of the crimper 32 can be moved in the main scanning direction to perform crimping at a plurality of points. As a result, two or more crimping marks can be formed by the binding operation of the upper crimping teeth 32a and the lower crimping teeth 32b, and those crimping marks are adjacent to each other. Accordingly, the binding strength of the sheet bundle Pb can be enhanced.

Methods of changing how the post-processing such as binding is performed or the number of times the crimp binding is performed for one sheet bundle Pb, depending on the condition of binding such as the number of sheets P that makes up the sheet bundle Pb for which post-processing such as binding is performed and the binding posture of the crimper 32 relative to the sheet bundle Pb, are described below.

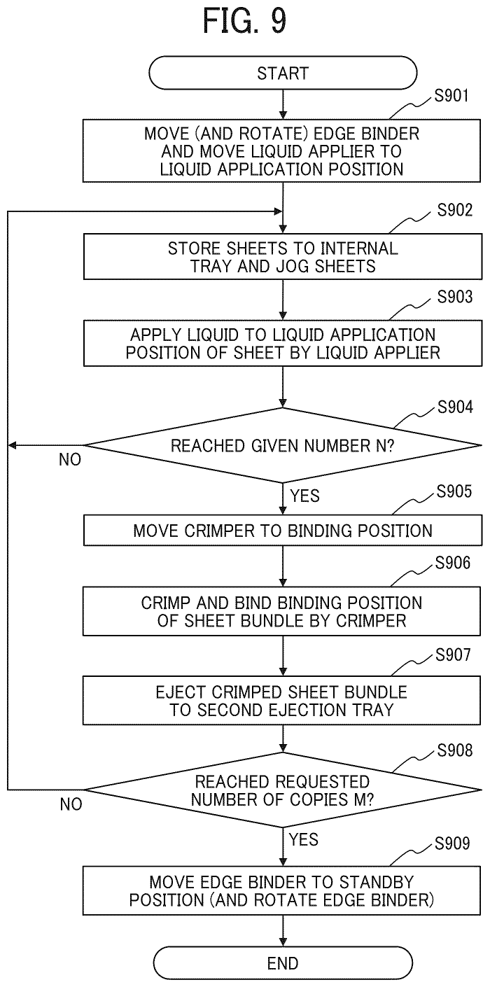

FIG. 9 is a flowchart of the processes performed by the edge binder 25 to execute one-point binding.

FIG. 10A to FIG. 10D are diagrams each of which illustrates the positions of the edge binder 25 (the liquid applier 31 and the crimper 32) during the one-point binding.

The position (liquid application position) to which liquid is applied on a sheet P or a sheet bundle Pb by the liquid applier 31 corresponds to the binding position on the sheet bundle Pb to be crimped by the crimper 32. For this reason, in the following description, the liquid application position and the binding position are denoted by the same reference sign (B1 or B2).

For example, the controller 100b starts the binding illustrated in FIG. 9 when the controller 100b acquires an instruction to execute the binding from the image forming apparatus 2. In the following description, the instruction to execute the binding may be referred to as a “binding command.”

The binding command includes, for example, the type of the sheet P (including information affecting the spread of liquid, such as material and thickness), the number of sheets P of the sheet bundle Pb, the number of sheet bundles Pb to be bound, the binding position on the sheet bundle Pb, and the binding posture of the edge binder 25. In the following description, the number of sheets P of the sheet bundle Pb may be referred to as “given number of sheets N” whereas the number of sheet bundles Pb to be bound may be referred to as “requested number of copies M.”

The liquid applier 31 and the crimper 32 are assumed to be in a parallel binding posture and located at a standby position HP (FIG. 10A) that is a position shifted in the width direction from the sheets P placed on the internal tray 22 at the start of the binding.

When the posture that is instructed by the binding command is the oblique binding posture, in step S901, the controller 100b drives the liquid-applier pivot motor 563 and the crimper pivot motor 56 to rotate the liquid applier 31 and the crimper 32 of the edge binder 25 into the oblique binding posture. Alternatively, when the posture that is instructed by the binding command is the “inclined binding posture,” the crimper 32 alone may be pivoted to the inclined binding posture and the liquid applier 31 may not be pivoted in both forward and reverse directions. Such a configuration can simplify the driving mechanism as compared with a configuration in which both the liquid applier 31 and the crimper 32 are rotated in both forward and reverse directions. Thus, the effects of cost reduction, the downsizing of the apparatus, and the reduction of a failure of devices are obtained.

On the other hand, when the posture that is instructed by the binding command is the “parallel binding posture,” the controller 100b omits the aforementioned operation of rotating the liquid applier 31 and the crimper 32 of the edge binder 25 to the oblique binding posture.

In step S901, the controller 100b drives the edge-binder movement motor 50 to move the edge binder 25 in the main scanning direction so that the liquid applier 31 faces the first liquid application position B1 instructed by the binding command. The controller 100b executes the operation of step S901 before a first sheet P is conveyed to the internal tray 22 by the conveyance roller pairs 10, 11, 14, and 15.

In step S902, the controller 100b rotates the conveyance roller pairs 10, 11, 14, and 15 to store the sheet P, on which the image has been formed by the image forming apparatus 2, onto the internal tray 22. In step S902, the controller 100b moves the side fences 24L and 24R in the main scanning direction to align the position of the sheet P or the sheet bundle Pb placed on the internal tray 22 in the main scanning direction. In short, the controller 100b performs so-called jogging.

In step S903, the controller 100b causes the liquid applier 31 facing the first liquid application position B1 to apply liquid to the first liquid application position B1 of the sheet P placed on the internal tray 22 in the immediately preceding step S902, based on the liquid application control data adjusted in advance. In other words, the controller 100b drives the liquid-applier movement motor 42 to bring the liquid application member 44 into contact with the first liquid application position B1 on the sheet P placed on the internal tray 22 (see FIG. 10B). In the liquid application process in step S903, the controller 100b adjusts the position at which the liquid application member 44 applies liquid to the sheet P in accordance with the type of the sheet P and the binding position included in the binding command. The controller 100b adjusts the amount of pressing the liquid application member 44 against the sheet P. In other words, the controller 100b controls the driving of the liquid-applier movement motor 42 based on the adjusted control data, and adjusts the amount of movement of the liquid application member 44 with respect to the first liquid application position B1 of the sheet P placed on the internal tray 22.

The controller 100b determines whether the number of sheets P placed on the internal tray 22 has reached the given number of sheets N instructed by the binding command (step S904). When the controller 100b determines that the number of sheets P placed on the internal tray 22 has not reached the given number of sheets N (NO in step S904), the controller 100b executes the operations of steps S902 to S904 again until the number of sheets P placed on the internal tray 22 reaches the given number of sheets N (YES in step S904). In other words, the controller 100b executes the processing of steps S902 to S904 each time the sheet P is conveyed to the internal tray 22 by the conveyance roller pairs 10, 11, 14, and 15. The liquid application by the liquid applier 31 may be performed not only on all of the plurality of sheets P included in the sheet bundle Pb but also on only some of the plurality of sheets P included in the sheet bundle Pb.

When the controller 100b determines that the number of sheets P placed on the internal tray 22 has reached the given number of sheets N (YES in step S904), in step S905, the controller 100b drives the edge-binder movement motor 50 to move the edge binder 25 in the main scanning direction such that the crimper 32 faces the first binding position B1 as illustrated in FIG. 10C.

In step S906, the controller 100b causes the crimper 32 to crimp the sheet bundle Pb placed on the internal tray 22. Subsequently, in step S907, the controller 100b causes the conveyance roller pair 15 to eject the sheet bundle Pb thus crimped and bound by the crimper 32 to the second output tray 26. Specifically, the controller 100b drives the contact-separation motor 32d to cause the upper crimping teeth 32a and the lower crimping teeth 32b to clamp the first binding position B1 on the sheet bundle Pb placed on the internal tray 22. The sheet bundle Pb is pressed and deformed between the upper crimping teeth 32a and the lower crimping teeth 32b, and thus the sheet bundle Pb is crimped. Then, the controller 100b rotates the conveyance roller pair 15 to eject the sheet bundle Pb thus crimped and bound to the second output tray 26.

The sheet bundle Pb that is placed on the internal tray 22 has a crimping area (corresponding to the first binding position B1) sandwiched between the upper crimping teeth 32a and the lower crimping teeth 32b in step S906. The crimping area overlaps a liquid application area (corresponding to the first liquid application position B1) contacted by the end of the liquid application member 44 in step S903. In other words, the crimper 32 crimps an area to which liquid is applied by the liquid applier 31 on the sheet bundle Pb placed on the internal tray 22. The crimping area that is clamped by the upper crimping teeth 32a and the lower crimping teeth 32b may completely or partially overlap with the liquid application area contacted by the front end of the liquid application member 44, to obtain a sufficient binding strength.

In step S908, the controller 100b determines whether the number of sheet bundles Pb thus ejected to the second output tray 26 has reached the requested number of copies M indicated by the binding command. When the controller 100b determines that the number of sheet bundles Pb thus ejected has not reached the requested number M of copies (NO in step S908), the controller 100b executes the operations of step S902 and the following steps again. In other words, when the controller 100b determines that the number of sheet bundles Pb thus ejected has not reached the requested number of copies M (NO in step S908), the controller 100b repeats the operations of step S902 to step S908 until the number of sheet bundles Pb ejected to the second output tray 26 reaches the requested number of copies M.

On the other hand, when the controller 100b determines that the number of sheet bundles Pb output to the second output tray 26 has reached the requested number of copies M (YES in step S908), in step S909, the controller 100b drives the edge-binder movement motor 50 to move the edge binder 25 (the liquid applier 31 and the crimper 32) to the standby position HP as illustrated in FIG. 10D. When the posture that is instructed by the binding command is the “oblique binding posture,” in step S909, the controller 100b drives the liquid-applier pivot motor 563 and the crimper pivot motor 56 to rotate the liquid applier 31 and the crimper 32 into the parallel binding posture. On the other hand, when the posture that is instructed by the binding command is the “parallel binding posture,” the controller 100b skips the aforementioned operation of rotating the liquid applier 31 and the crimper 32 to the parallel binding posture. As a result, the edge binder 25 that includes the liquid applier 31 and the crimper 32 returns to the standby position HP position illustrated in FIG. 10D. In steps S901 and S909, the execution order of the movement in the main scanning direction and the rotation in both forward and reverse directions of the liquid applier 31 and the crimper 32 is not limited to the aforementioned order and may be reversed.

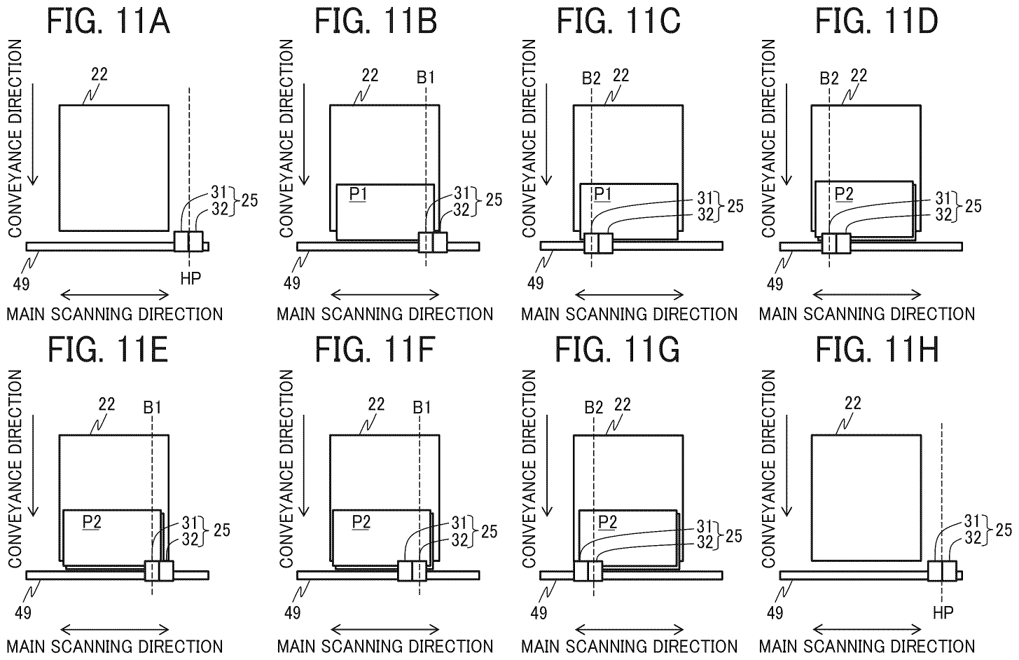

FIG. 11A to FIG. 11H are diagrams illustrating the positions of the edge binder 25 during the operation of a two-point binding.

As illustrated in FIG. 11A, it is assumed that the edge binder 25 is located at the standby position HP at the start point of the two-point binding. The first binding position B1 and the second binding position B2 are positions separated from each other in the main scanning direction. In FIG. 11A to FIG. 11H, cases where two sheets P are crimped and bound (i.e., N=2) are illustrated. In the case of executing the two-point binding, the number of sheets P included in the sheet bundle Pb is not limited to two, and the two-point binding can be performed on a sheet bundle Pb having the same number of sheets as the number of sheets that can be bound in one-point binding.

Before a first sheet P1 for a sheet bundle Pb is supplied to the internal tray 22, the controller 100b moves the edge binder 25 in the main scanning direction such that the liquid applier 31 can face the first liquid application position B1 (see FIG. 11B). As illustrated in FIG. 11B, the liquid applier 31 is disposed at a position at which the liquid applier 31 can face the first crimp binding position B1. In such a state, the controller 100b causes the first sheet P1, on which an image has been formed by the image forming apparatus 2, to be placed on the internal tray 22 and performs the jogging on the first sheet P1. In response to the placement of the first sheet P1 on the internal tray 22, the controller 100b causes the liquid applier 31 to apply the liquid to the first liquid application position B1 of the first sheet P1.

Then, as illustrated in FIG. 11C, the controller 100b causes the edge binder 25 to move in the main scanning direction such that the liquid applier 31 faces the second liquid application position B2 of the first sheet P1. Then, the controller 100b causes the liquid applier 31 to apply the liquid to the second liquid application position B2 of the first sheet P1.

In response to the application of the liquid to the first liquid application position B1 and the second liquid application position B2 of the first sheet P1, the controller 100b causes a second sheet P2 for the sheet bundle Pb to be placed on the internal tray 22 and performs the jogging on the second sheet P2 in a state where the liquid applier 31 is disposed at a position which the liquid applier 31 can face the second liquid application position B2 as illustrated in FIG. 11D. In response to the placement of the second sheet P2 on the internal tray 22, the controller 100b causes the liquid applier 31 to apply the liquid to the second liquid application position B2 of the second sheet P2.

Then, as illustrated in FIG. 11E, the controller 100b causes the edge binder 25 to move in the main scanning direction such that the liquid applier 31 faces the first liquid application position B1 of the second sheet P2. Subsequently, the controller 100b causes the liquid applier 31 to apply the liquid at the first liquid application position B1 of the second sheet P2.

In other words, the controller 100b controls the conveyance roller pairs 10, 11, 14, and 15 and the liquid applier 31 to repeat the conveyance of the sheet P and the liquid application to the first liquid application position B1 and the second liquid application position B2 until the number of sheets P placed on the internal tray 22 reaches the given number of sheets N. In so doing, the controller 100b causes the liquid applier 31 to apply the liquid to the B-th sheet P (B<N) in the order of the first liquid application position B1 and the second liquid application position B2. The controller 100b also causes the liquid applier 31 to apply the liquid to the (B+1)-th sheet P in the order of the second liquid application position B2 and the first liquid application position B1. In other words, the controller 100b changes the order in which the liquid applier 31 applies the liquid to the first liquid application position B1 and the second liquid application position B2 for each sheet P. The controller 100b also causes the edge binder 25 to move from one side of the first liquid application position B1 and the second liquid application position B2 to the other side of the first liquid application position B1 and the second liquid application position B2 in the shortest distance without passing through the standby position HP.

Subsequently, in response to a determination that the number of sheets P placed on the internal tray 22 has reached the given number of sheets N, the controller 100b causes the edge binder 25 to move in the main scanning direction such that the crimper 32 faces the first binding position B1 as illustrated in FIG. 11F. The controller 100b causes the crimper 32 to perform crimp binding on the first binding position B1 of the sheet bundle Pb placed on the internal tray 22.

Then, as illustrated in FIG. 11G, the controller 100b causes the edge binder 25 to move in the main scanning direction such that the crimper 32 faces the second binding position B2. The controller 100b causes the crimper 32 to perform crimp binding on the second binding position B2 of the sheet bundle Pb placed on the internal tray 22.

In the example illustrated in FIG. 11A to FIG. 11H, the liquid is finally applied to the first crimp binding position B1, and the crimp binding is performed in the order of the first binding position B1 and the second binding position B2. On the other hand, when the liquid is finally applied to the second binding position B2, the crimp binding is performed in the order of the second binding position B2 and the first binding position B1.

The controller 100b outputs the sheet bundle (sheet bundle) Pb crimped and bound at the first binding position B1 and the second binding position B2 to the second output tray 26. Further, as illustrated in FIG. 11H, the controller 100b causes the edge binder 25 to move to the standby position HP.

According to the present embodiment, one or two positions of the sheet bundle Pb are crimped and bound. However, no limitation is indicated thereby, and three or more positions of the sheet bundle Pb that are spaced in the main scanning direction may be crimped and bound. In such cases, the controller 100b causes the liquid applier 31 to apply the liquid to three or more liquid application positions (corresponding to the crimp binding positions) and causes the crimper 32 to perform crimp binding. The productivity of the crimp binding can be increased even when three or more positions are crimped and bound.

However, it is not necessary to apply the liquid to all the liquid application positions (corresponding to crimp binding positions) for all the sheets P included in the sheet bundle Pb. For example, when crimp binding is performed on three liquid application positions (corresponding to crimp binding positions) apart from each other in the main scanning direction, the controller 100b may cause the liquid applier 31 to apply the liquid to three liquid application positions (corresponding to crimp binding positions) of an E-th sheet P1 (E<N−2), apply the liquid to two liquid application positions (corresponding to crimp binding positions) of an (E+1)-th sheet P2, and apply the liquid to one liquid application position (corresponding to a crimp binding position) of an (E+2)-th sheet P2.

The liquid application member 44 is made of a material that can contain and keep liquid, and as the number of times the liquid application member 44 contacts the sheet P and is pressed against the sheet P increases in the liquid applying operation, the liquid application member 44 may be worn.

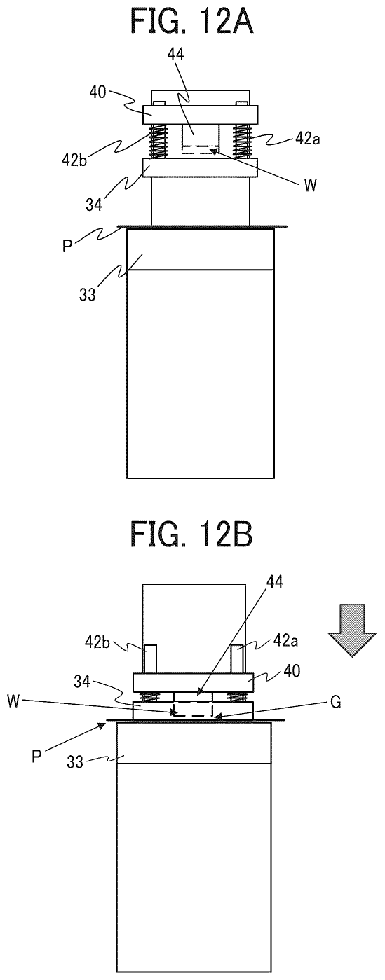

FIG. 12A and FIG. 12B are diagram illustrating the liquid application member 44 that is worn, where its length is shortened than the original dimension, according to a comparative example.

A worn portion W in FIG. 12A and FIG. 12B indicates how much the liquid application member 44 is shortened than the initial length due to, for example, the liquid applying operation. In other words, a worn portion W in FIG. 12A and FIG. 12B indicates the portion lost due to wear and tear.

FIG. 12A indicates a state before the liquid applying operation is performed. Even when the length of the liquid application member 44 is shortened due to the worn portion W, no difference is made to the standby position of the liquid application member is determined in initial settings, and the standby position remains the same. FIG. 12B indicates a state in which the liquid application member 44 has moved downward to the sheet P by a predetermined distance after the liquid application has started.

When the liquid application is performed, the liquid-applier movement motor 37 moves the liquid application member 44 toward the sheet P by a certain distance. As the travel distance of the liquid application member 44 in the liquid application is determined in advance to have a fixed value, the liquid application member 44 does not reach the sheet P in a sufficient manner if the liquid application member 44 is shortened as indicated in FIG. 12A by the worn portion W. In other words, the liquid application member 44 does not contact the sheet P, or the liquid application cannot sufficiently be done even if the liquid application member 44 contacts the sheet P.

When the liquid application member 44 is worn, as illustrated in FIG. 12B, a gap G may appear between the sheet P and the liquid application member 44. As a result, some adverse effects may be present. For example, the amount of the liquid applied to the sheet P is reduced or the liquid application ends in failure. When the amount of the liquid applied to the sheet P decreases to an amount smaller than a predetermined amount, there is some concern that the binding force in the binding to be performed afterward is weakened and the binding quality decreases.

### First Example

An example is described in which the above adverse effects that are possibly caused by the wear and tear of the liquid application member 44 are prevented and the amount of the liquid applied to the sheet P by the liquid applier 31 is maintained constant.

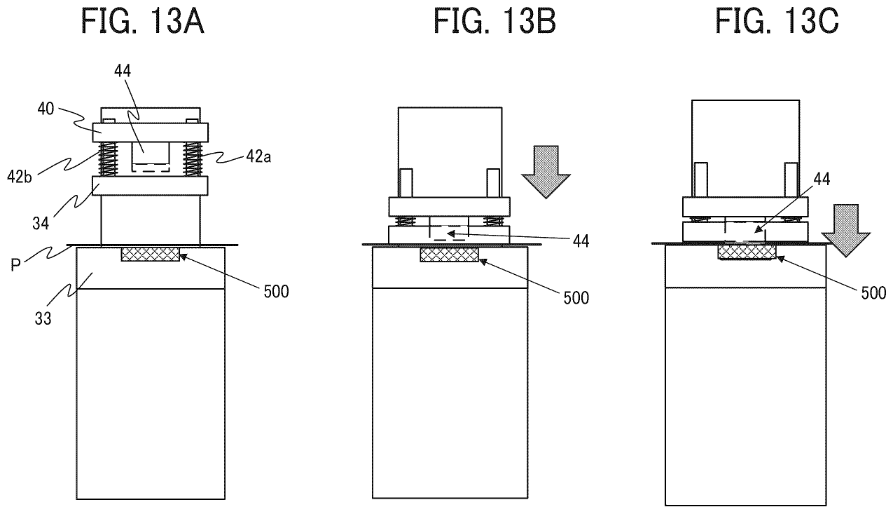

FIG. 13A to FIG. 13C are diagrams illustrating the liquid applier 31 according to a first example.

The liquid applier 31 according to the present example has a load cell 500, which serves as a load converter, on the lower pressure plate 33.

As illustrated in FIG. 13A, the load cell 500 is arranged directly below a position toward which the liquid application member 44 descends. Due to such a configuration, when the liquid application member 44 moves downward and contacts the sheet P, pressure is applied onto the lower pressure plate 33 through the sheet P. In response to that pressure, the load cell 500 outputs an electrical signal to the controller 100b. Based on the electrical signal sent from the load cell 500, the controller 100b determines whether the liquid application member 44 has contacted the sheet P and has done the liquid application. By making determination based on the electrical signal sent from the load cell 500, the controller 100b can determine whether the liquid application member 44 has done pressing in the liquid applying operation for sufficient contact time to apply the liquid to the sheet P. In other words, by making determination based on the electrical signal sent from the load cell 500, the controller 100b can determine whether predetermined liquid applying operation has done even if the liquid application member 44 is worn. Accordingly, when it is determined that the liquid applying operation is insufficiently done, the controller 100b controls, for example, the travel distance for pressing to be longer. Alternatively, the contact time may be adjusted.

When it is determined that the liquid applying operation is sufficiently done and the amount of the liquid applied to the sheet P is equal to or greater than a predetermined amount, the controller 100b causes the liquid-applier movement motor 37 to stop or move upward. Due to such a configuration, the liquid can be applied to the sheet P with reliability.

The liquid-applier movement motor 37 may be moved downward until the load cell 500 senses a load caused by the liquid application member 44. Technical problems that the liquid application member 44 cannot contact the sheet P and the liquid application cannot be done may be addressed or solved by such a configuration.

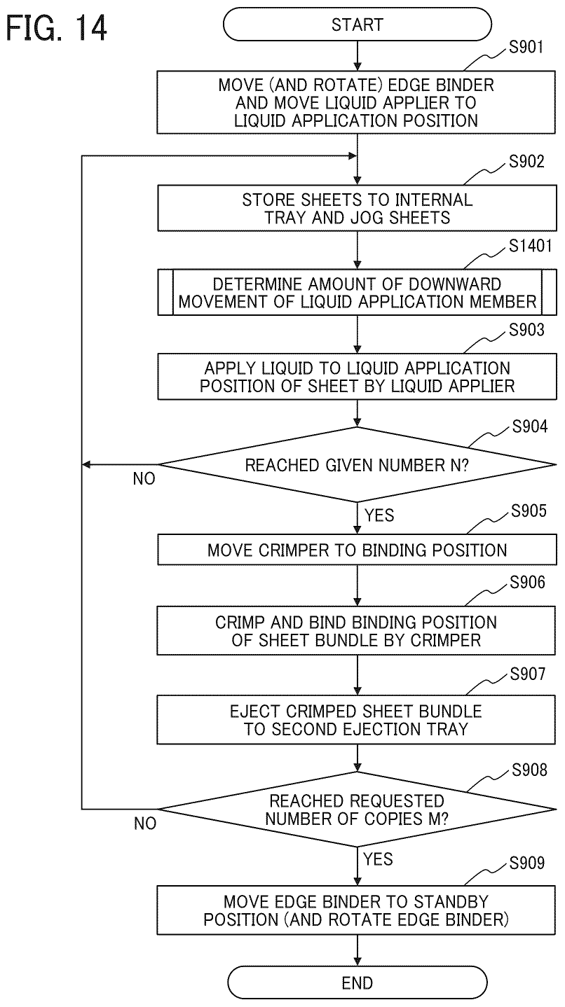

FIG. 14 is a flowchart of the liquid applying operation according to a first example.

In the flowchart of FIG. 14, step S1401 in which whether the amount of downward movement of the liquid application member 44 is appropriate is determined is added to the liquid applying operation described above with reference to FIG. 9. The processes equivalent to the processes described above with reference to FIG. 9 are described in a simplified manner, and processes according to the first example are described below in detail.

In step S901, the controller 100b drives the edge-binder movement motor 50 to move the edge binder 25 in the main scanning direction so that the liquid applier 31 faces the first liquid application position B1 instructed by the binding command.

Subsequently, in step S902, the controller 100b stores the sheet P on which the image has been formed by the image forming apparatus 2 in the internal tray 22. In short, the controller 100b performs so-called jogging.

Subsequently, in step S1401, the amount of downward movement of the liquid application member 44 is determined.

FIG. 15 is a flowchart of the detailed processes of step S1401, according to the first example.

In step S1501, the controller 100b lowers the liquid applier or the liquid application member 44 toward the first liquid application position B1 of the sheet P placed on the internal tray 22 in the previous step S902. When it is determined that the level of pressing force detected by the load cell 500 has not reached a specified value based on the liquid application control data that is adjusted in advance (NO in step S1502), in step S1501, the downward movement is continued.

When it is determined that the level of pressing force detected by the load cell 500 has reached a specified value (YES in step S1502), the determination of the amount of downward movement of the liquid application member 44 is terminated. Return to FIG. 14. As illustrated in FIG. 14, the liquid application equivalent to the process in step S903 as described above is performed. The processes in step S903 and the following steps are equivalent to the processes described above with reference to FIG. 9.

### Second Example

An example is described below in which the standby position of the liquid application member 44 is changed. Such changes are made to address or solve a technical problem caused by wear and tear of the liquid application member 44. More specifically, due to such wear and tear of the liquid application member 44, the liquid application member 44 does not contact the sheet P in a sufficient manner with a present amount of downward movement of the liquid application member 44, and the liquid application cannot sufficiently be done.

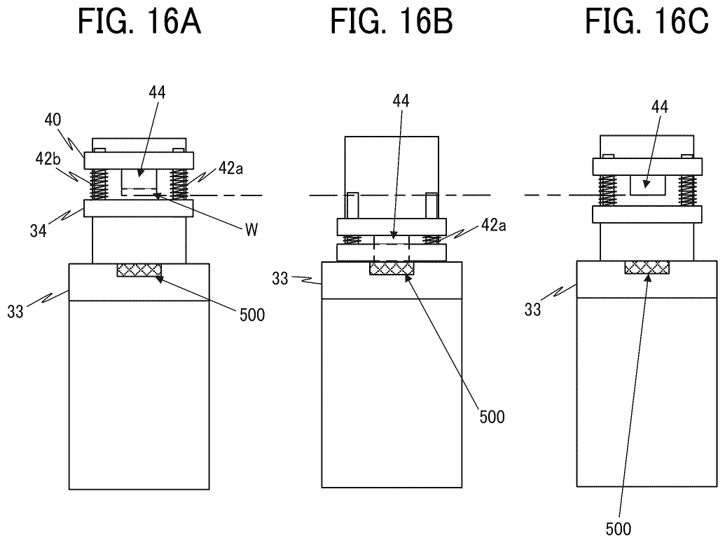

As illustrated in FIG. 16A, the liquid applier 31 according to the present example also has the load cell 500. In the present example, as illustrated in FIG. 16B, under the condition that the sheet P has not yet conveyed to the lower pressure plate 33, the liquid application member 44 is moved downward until the controller 100b determines that the liquid application member 44 has touched the load cell 500. By so doing, the amount of downward movement required for the liquid application member 44 from the initial standby position of the liquid application member 44 to a position where the load cell 500 senses a load or pressing force caused by the liquid application member 44 can be determined.

Such a required amount of downward movement is greater than a preset amount of downward movement by the length of the worn portion W. In view of the above circumstances, as illustrated in FIG. 16C, the set value of the standby position is changed such that a required amount of downward movement will be achieved with a preset amount of downward movement.

As described above, the standby position is changed in the present example. Due to such a configuration, even if the worn liquid application member 44 is used, the amount of the liquid applied to the sheet P can be maintained at an amount equivalent to the amount before the liquid application member 44 is worn. Moreover, the length of time that the liquid application member 44 has moved downward and the distance that the liquid application member 44 has moved downward while the liquid application member 44 moves from the standby position to a position where the liquid is applied to the sheet P can also be remains unchanged. The amount of wear and tear of the liquid application member 44 can be detected regardless of the thickness of the sheets or the number of sheets.

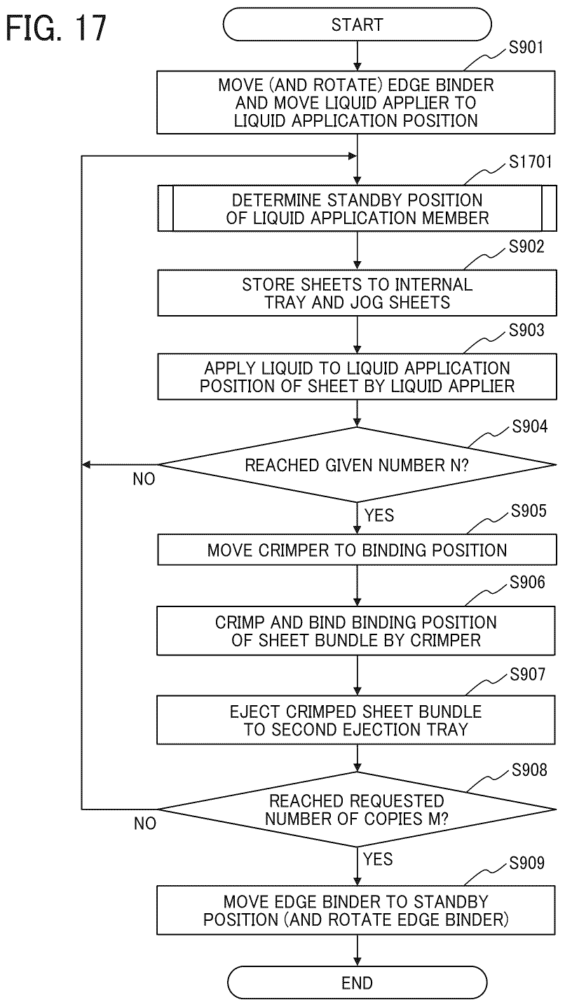

FIG. 17 is a flowchart of the liquid applying operation according to a second example.

In addition to the liquid applying operation described above with reference to FIG. 9, in step S1701, the standby position of the liquid application member is determined. The processes equivalent to the processes described above with reference to FIG. 9 are described in a simplified manner, and processes according to the second example are described below in detail.

In step S901, the controller 100b drives the edge-binder movement motor 50 to move the edge binder 25 in the main scanning direction so that the liquid applier 31 faces the first liquid application position B1 instructed by the binding command.

Subsequently, the controller 100b stores the sheet P in the internal tray 22, and in step S1701, the standby position of the liquid application member is determined prior to step S902 where so-called jogging is performed.

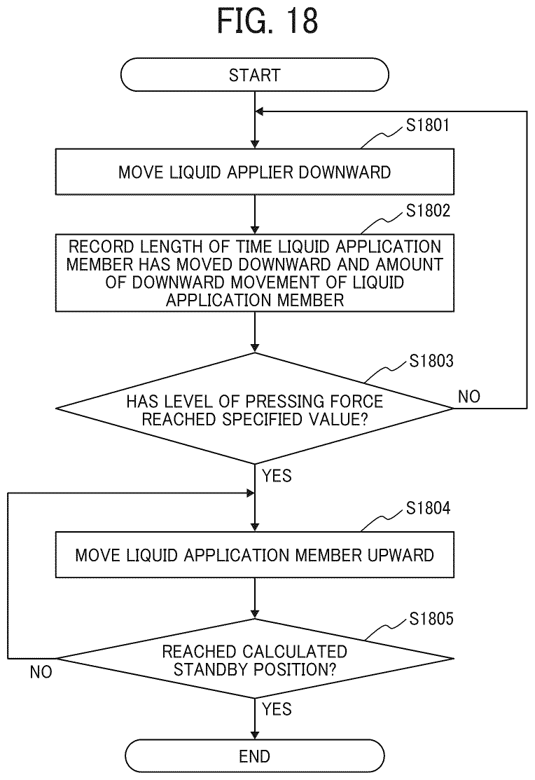

FIG. 18 is a flowchart of the detailed processes of step S1701, according to the second example.

In step S1801, the controller 100b lowers the liquid applier or the liquid application member 44 toward the lower pressure plate 33 onto which the sheet P is not yet placed. In step S1802, the length of time that the liquid application member 44 has moved downward and the amount of downward movement of the liquid application member 44 is recorded when it is determined that the level of pressing force detected by the load cell 500 has not reached a specified value based on the liquid application control data that is adjusted in advance (NO in step S1803), and the downward movement of the liquid application member 44 is continued.

When it is determined that the level of pressing force detected by the load cell 500 has reached a specified value (YES in step S1803), in step S1804, the liquid application member 44 is moved upward. The controller 100b calculates the standby position required to achieve a desired amount of downward movement with reference to the initial value for the standby position, based on the length of time that the liquid application member 44 has moved downward and the amount of downward movement of the liquid application member 44, which were recorded in step S1802.

When it is determined that the liquid application member 44 has not reached the calculated standby position (NO in step S1805), the controller 100b moves the liquid application member 44 upward. When it is determined that the liquid application member 44 has reached the standby position (YES in step S1805), the controller 100b terminates this series of processes for adjusting the standby position of the liquid application member 44. Due to such a configuration, the height of the standby position of the liquid application member 44 can be made the same before and after the wear and tear.

Return to FIG. 17. As illustrated in FIG. 17, after the standby position of the liquid application member is determined in step S1701, the liquid application equivalent to the process in step S902 as described above is performed. The processes in step S903 and the following steps are equivalent to the processes described above with reference to FIG. 9.

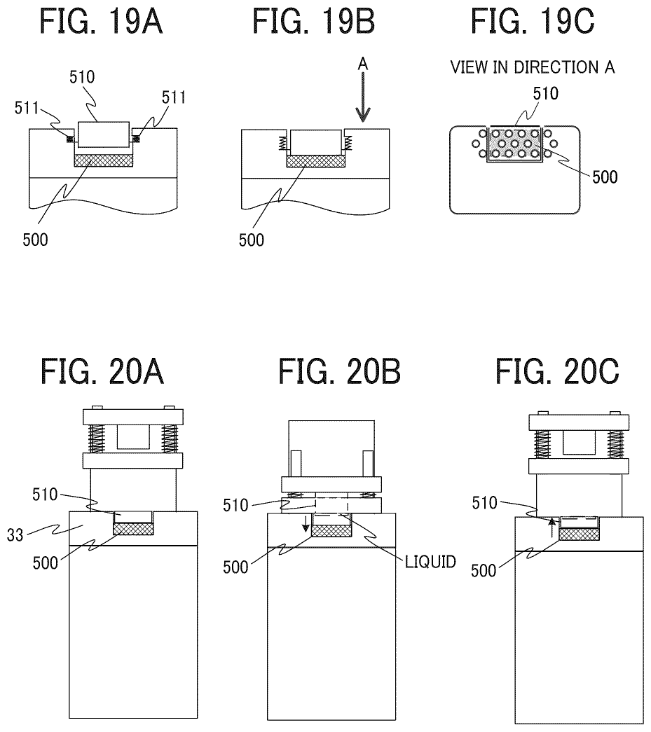

FIG. 19A to FIG. 20C are diagrams illustrating structures and operations of the liquid applier 31 according to the second example.

In the second example, the liquid application member 44 may contact and press the load cell 500 directly for the adjustment of the standby position. In such cases, the load cell 500 may get wet due to the liquid, and this may cause a failure or damage. In order to handle such a situation, in the liquid applier 31 according to the present example, as illustrated in FIG. 19A, a movable part 510 that stores liquid is arranged directly above the load cell 500 that is laid over the lower pressure plate 33. This arrangement prevents the load cell 500 from direct exposure to the liquid.

As illustrated in FIG. 19A, the movable part 510 is provided with a pair of support springs 511 for the lower pressure plate 33. As illustrated in FIG. 19B, the movable part 510 moves downward by the pair of support springs 511 when downward pressure is applied. When such downward pressure is absent, the movable part 510 returns to the position illustrated in FIG. 19A due to the elasticity of the support spring 511.

As illustrated in FIG. 19C, the movable part 510 is arranged above the load cell 500.

The operation of the liquid applier 31 according to the present example is described below. As illustrated in FIG. 20A, when the liquid application member 44 goes on standby, the height of the movable part 510 is equal to that of the lower pressure plate 33. As illustrated in FIG. 20B, when the liquid applier 31 performs the liquid applying operation, the liquid application member 44 contacts the movable part 510, and the movable part 510 is pushed down. The movable part 510 that is pushed down contacts the load cell 500, and when the load cell 500 is pushed down by a certain amount through the load cell 500, the liquid-applier movement motor 37 makes the liquid application member 44 stop or move upward. When the liquid application member 44 moves upward, the movable part 510 is moved upward and returns to the standby position by the support spring 511. Due to such mechanisms, the load cell 500 can be prevented from being damaged by liquid, and the amount of the liquid to be applied can be adjusted by detecting the pushing force applied to the movable part 510.

### Third Example

Technical problems of the liquid applying operation due to wear and tear of the liquid application member 44 are addressed below. Another example is described in which the amount of the liquid applied to the sheet P can be maintained constant.

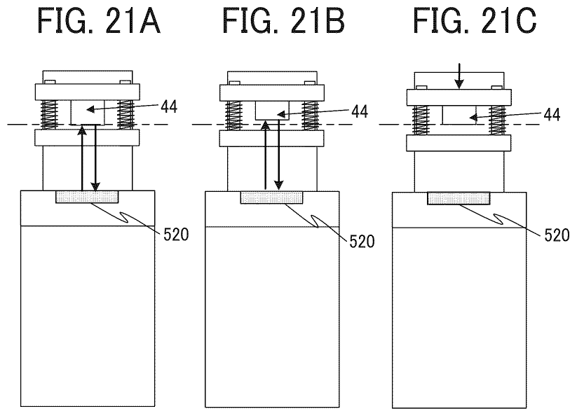

FIG. 21A to FIG. 21C are diagrams illustrating the liquid applier 31 according to a third example.

The liquid applier 31 according to the present example has the reflection sensor 520 on the lower pressure plate 33.

As illustrated in FIG. 21A, the reflection sensor 520 is arranged directly below the liquid application member 44. As illustrated in FIG. 21B, the distance between the reflection sensor 520 and the liquid application member 44 at a standby position is compared before and after the wear and tear. As illustrated in FIG. FIG. 21C, the standby position of the liquid application member 44 after wear and tear is adjusted based on the result of the comparison to level with the standby position of the liquid application member 44 before the wear and tear.

Due to such a configuration, the length of time of downward movement and the amount of downward movement from the standby position for the liquid application member 44 to contact the sheet P and apply the liquid to the sheet P is made constant, and the amount of the liquid applied to the sheet P can be maintained at an amount equivalent to the amount before the liquid application member 44 is worn. According to the present example, the standby position can be adjusted to a desired position without moving the liquid application member 44 downward as described above in the first example and the second example.

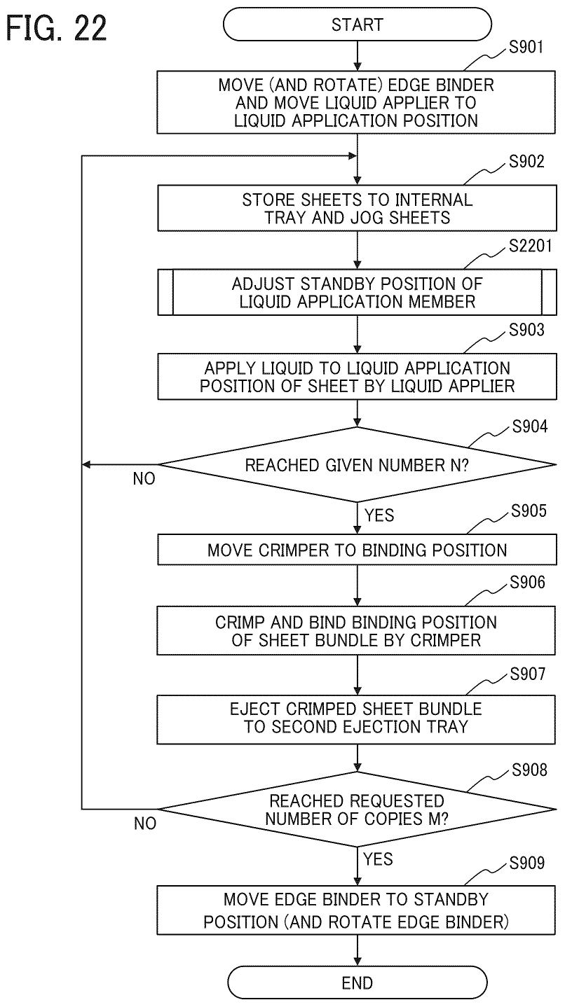

FIG. 22 is a flowchart of the liquid applying operation according to a third example.

In addition to the liquid applying operation described above with reference to FIG. 9, in step S2201, the standby position of the liquid application member is adjusted. The processes equivalent to the processes described above with reference to FIG. 9 are described in a simplified manner, and processes according to the fourth example are described below in detail.

In step S901, the controller 100b drives the edge-binder movement motor 50 to move the edge binder 25 in the main scanning direction so that the liquid applier 31 faces the first liquid application position B1 instructed by the binding command.

Subsequently, in step S902, the controller 100b stores the sheet P on which the image has been formed by the image forming apparatus 2 in the internal tray 22. In short, the controller 100b performs so-called jogging.

Subsequently, in step S2201, the standby position of the liquid application member 44 according to the third example is adjusted.

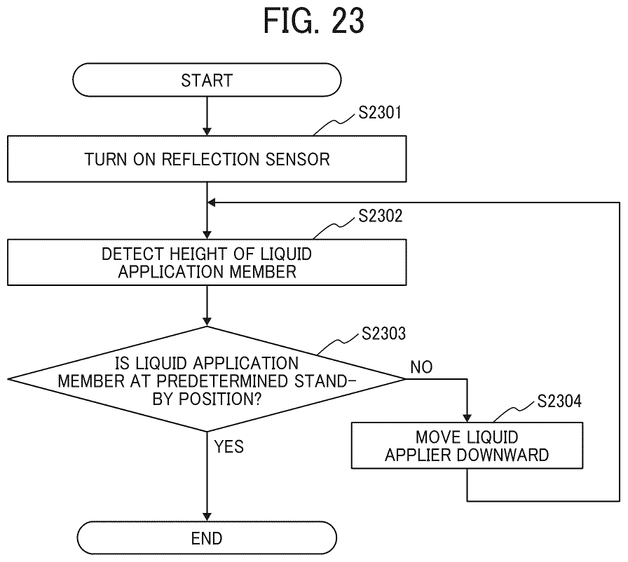

FIG. 23 is a flowchart of the detailed processes of step S2201, according to the third example.

In step S2301, the controller 100b turns on the reflection sensor 520. At this moment in time, the liquid application member 44 is at a predetermined standby position.

In step S2302, the controller 100b obtains the results of the detection performed by the reflection sensor 520. In step S2303, the controller 100b determines whether the obtained results of detection are appropriate. If the height of the plane where the liquid application member 44 contacts the sheet P is not appropriate at a predetermined standby position (NO in step S2303), in step S2304, the liquid application member 44 is moved downward.

The controller 100b loops the processes in steps S2302, S2303, and S2304 until the standby position of the liquid application member 44 is adjusted and the liquid can be applied to the sheet P in the liquid applying operation.

When the liquid application member 44 reaches an appropriate height (YES in step S2303), the controller 100b ends this series of processes for adjusting the standby position of the liquid application member.

Return to FIG. 22. As illustrated in FIG. 22, after the standby position of the liquid application member 44 is adjusted in step S2201, the processes in step S903 and the following steps as described above are performed.

### Fourth Example

Technical problems of the liquid applying operation due to wear and tear of the liquid application member 44 are addressed below. Another example is described in which the amount of the liquid applied to the sheet P can be maintained constant.

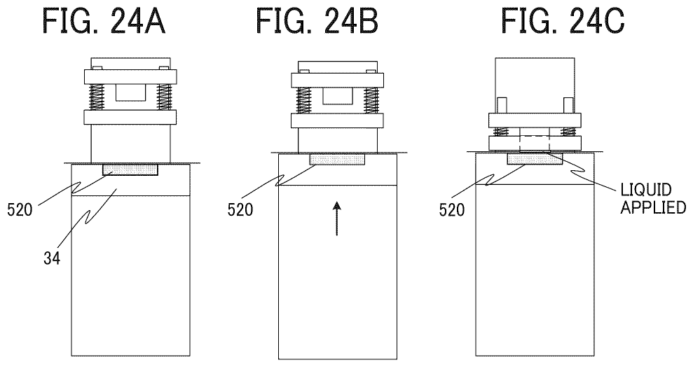

FIG. 24A to FIG. 24C are diagrams illustrating the liquid applier 31 according to a fourth example.

The liquid applier 31 according to the present example has the reflection sensor 520 on the lower pressure plate 33. Moreover, the liquid applier 31 according to the present example has a mechanism for moving the lower pressure plate 33.

In a similar manner to the third example, the liquid applier 31 according to the present example has the reflection sensor 520 on the lower pressure plate 33, and the reflection sensor 520 detects the distance to the liquid application member 44 to obtain the height of the liquid application member 44. As illustrated in FIG. 24A, the height of the standby position of the liquid application member 44 is measured by the reflection sensor 520 and recorded before the liquid application member 44 is worn.

When the liquid applying operation is executed, firstly, the height of the liquid application member 44 is measured, and the obtained height is compared with an initial value. When the height of the liquid application member 44 is increased due to wear and tear, as illustrated in FIG. 24B, the lower pressure plate 33 is moved upward.

After the lower pressure plate 33 is moved upward and the distance between the sheet P and the liquid application member 44 is adjusted to have a predetermined value, as illustrated in FIG. 24C, the liquid applying operation is executed.

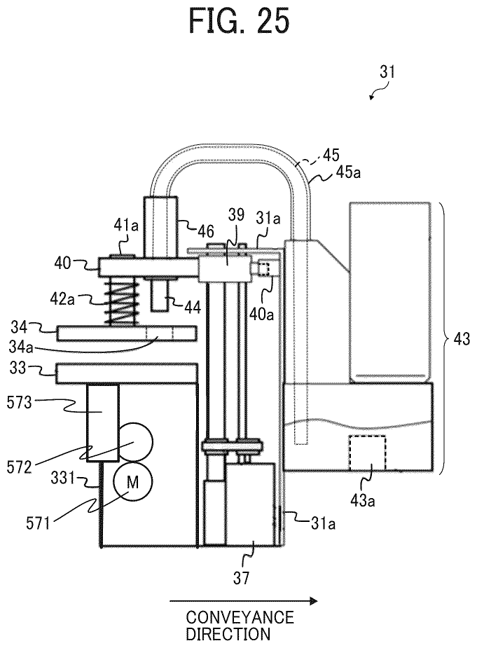

FIG. 25 is a side view of the liquid applier 31 according to a fourth example.

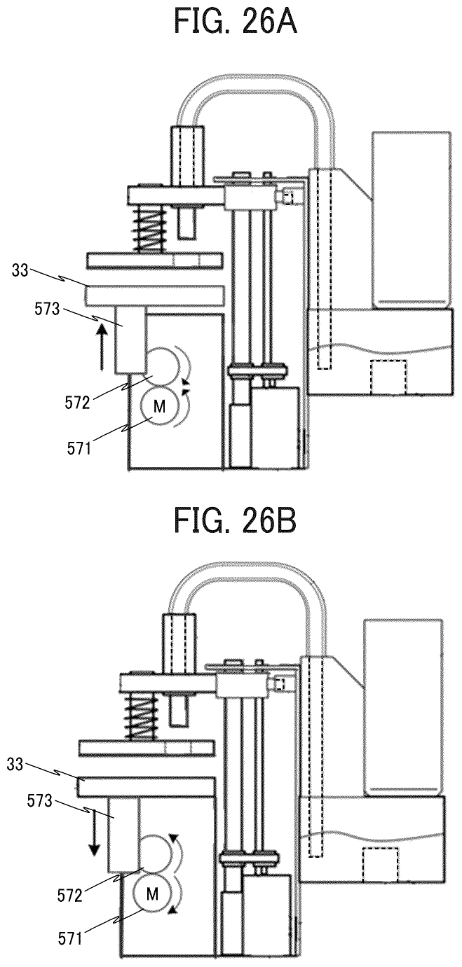

FIG. 26A and FIG. 26B are diagrams illustrating the upward movement and the downward movement of the lower pressure plate 33 according to the fourth example.

As illustrated in FIG. 25, a motor 541, a gear 572, and a movable part 573 are arranged. The gear 572 is connected to the drive shaft of the motor 541, and the movable part 573 can move in the up and down directions by the rotation of the gear 572.

As illustrated in FIG. 26A, the motor 541 is driven to rotate in the reverse direction based on the position data of the liquid application member 44 before and after the wear and tear, which is obtained by the reflection sensor 520. As a result, the lower pressure plate 33 moves upward by a certain degree through the gear 572 and the movable part 573. When the motor 541 rotates in the normal direction as illustrated in FIG. 26B, the lower pressure plate 33 moves downward to the standby position, and the lower pressure plate 33 can accept the next sheet P.

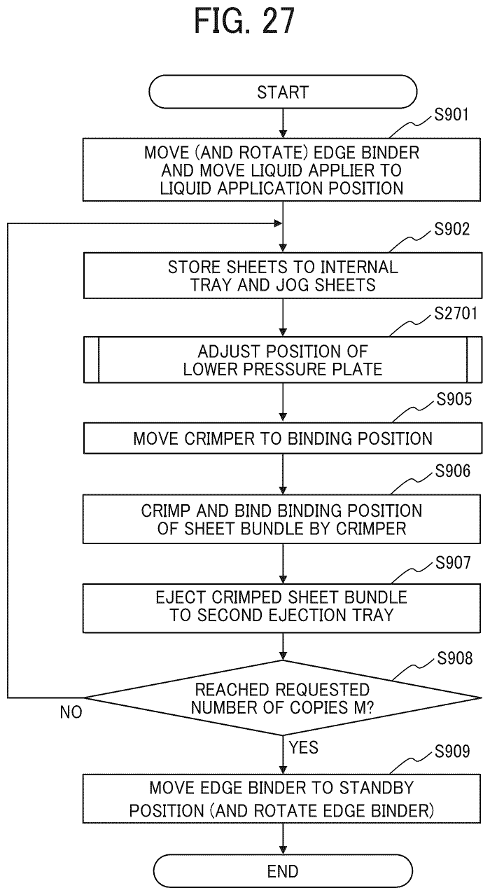

FIG. 27 is a flowchart of the liquid applying operation according to a fourth example.

In addition to the liquid applying operation described above with reference to FIG. 9, in step S2701, the position of the lower pressure plate 33 is adjusted. The processes equivalent to the processes described above with reference to FIG. 9 are described in a simplified manner, and processes according to the fourth example are described below in detail.

In step S901, the controller 100b drives the edge-binder movement motor 50 to move the edge binder 25 in the main scanning direction so that the liquid applier 31 faces the first liquid application position B1 instructed by the binding command.

In step S902, the controller 100b stores the sheet P on which the image has been formed by the image forming apparatus 2 in the internal tray 22. In short, the controller 100b performs so-called jogging.

Subsequently, in step S2701, the position of the lower pressure plate 33 is adjusted.

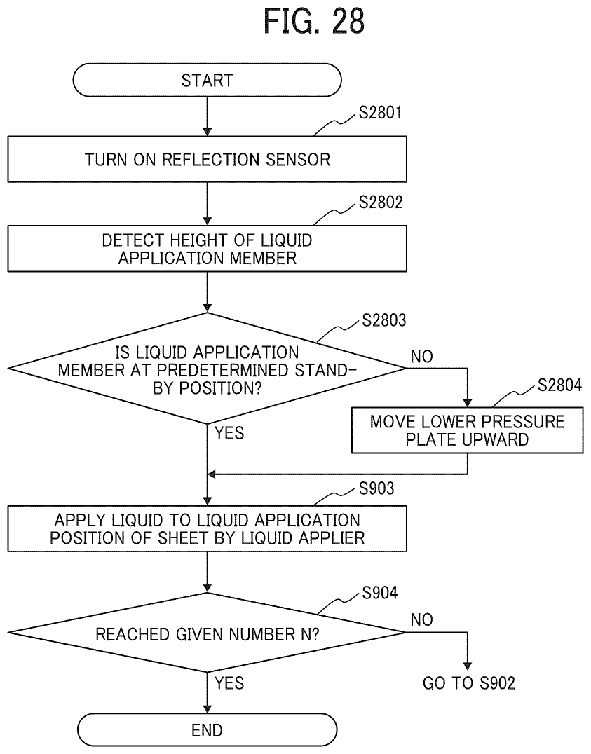

FIG. 28 is a flowchart of the detailed processes of step S2701, according to the fourth example.

In step S2801, the controller 100b activates the reflection sensor 520. At this moment in time, the liquid application member 44 is at a predetermined standby position.

In step S2802, the controller 100b obtains the results of the detection performed by the reflection sensor 520. In step S2803, the controller 100b determines whether the obtained results of detection are appropriate. If the height of the plane where the liquid application member 44 contacts the sheet P is not appropriate at a predetermined standby position (NO in step S2803), in step S2804, the lower pressure plate 33 is moved upward. If the height of the plane where the liquid application member 44 contacts the sheet P is appropriate at a predetermined standby position (YES in step S2803), the position of the lower pressure plate 33 is not changed.

In step S903, the controller 100b causes the liquid applier 31 facing the first liquid application position B1 to apply liquid to the first liquid application position B1 of the sheet P placed on the internal tray 22 in step S902, based on the liquid application control data adjusted in advance.

The controller 100b determines whether the number of sheets P placed on the internal tray 22 has reached the given number of sheets N instructed by the binding command (step S904). When the controller 100b determines that the number of sheets P placed on the internal tray 22 has not reached the given number of sheets N (NO in step S904), the process proceeds to step S902. When the number of sheets P placed on the internal tray 22 has reached the given number of sheets N, the process is shifted to step S905.

### Fifth Example

Technical problems of the liquid applying operation due to wear and tear of the liquid application member 44 are addressed below. Another example is described in which the amount of the liquid applied to the sheet P can be maintained constant.

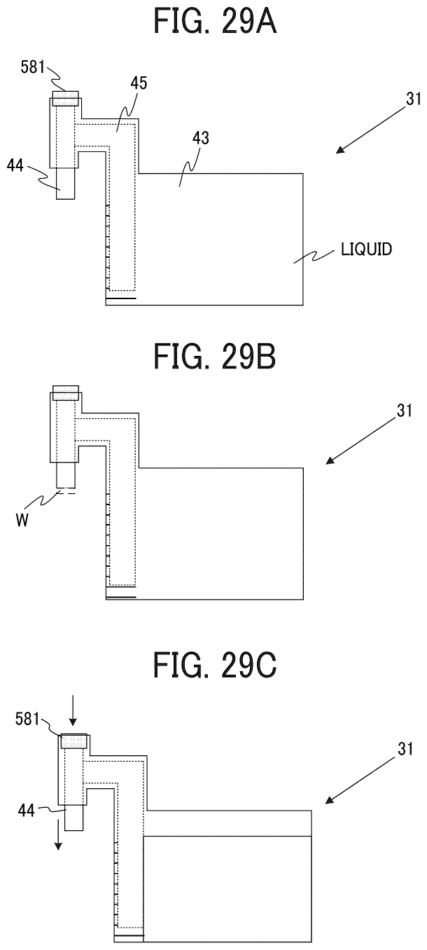

FIG. 29A to FIG. 29C are diagrams illustrating the liquid applier 31 according to a fifth example.

The liquid applier 31 according to the present example has an adjustment mechanism for adjusting the amount of protrusion of the liquid application member 44 to compensate for the amount of wear and tear of the liquid application member 44.

As illustrated in FIG. 29A to FIG. 29C, the liquid applier 31 is provided with a pushing member 581. The pushing member 581 is a mechanism for pushing the liquid application member 44 by the amount scraped and lost due to wear and tear.

In the first example to the fourth example, the liquid application member 44 is moved up and down by the liquid-applier movement motor 37 provided for the liquid applier 31, and the distance between the liquid application member 44 and the lower pressure plate 33 is adjusted so as to be unchanged before and after the wear and tear. By so doing, the amount of the liquid applied to the sheet P is stabilized.

In the liquid applier 31, the liquid application member 44 is pushed off to achieve a desired amount of pushing movement equivalent to the amount of pushing movement before the liquid application member 44 is worn, and a fixed amount of liquid can be applied to the sheet P regardless of whether the liquid application is to be performed before or after the liquid application member 44 is worn.

In the fifth example, a configuration or structure similar to that of the above-described configuration or structure according to the first to fourth examples may be adopted. In other words, the liquid applier 31 has the load cell 500 or the reflection sensor 520 on the lower pressure plate 33, and the distance between the liquid application member 44 and the load cell 500 or the reflection sensor 520 before and after the wear and tear is compared. The pushing member 581 may push down the liquid application member 44 based on the results of the comparison to achieve a desired amount of pushing movement equivalent to the amount of pushing movement before the liquid application member 44 is worn.

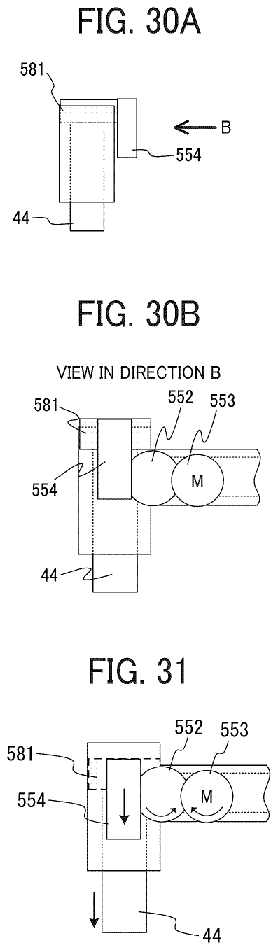

FIG. 30A and FIG. 30B are diagrams illustrating a pushing-level adjuster 550 for the liquid application member 44, including a pushing member 581, a gear 552, a motor 553, and a lifting and lowering unit 554.

The lifting and lowering unit 554, the gear 552, and the motor 553 are coupled to the pushing member 581.

As illustrated in FIG. 31, the pushing member 581 can move in both the upward and downward directions by driving the motor 553 to rotate. Due to such a configuration, a fixed amount of liquid can be applied to the sheet P regardless of whether the liquid application is to be performed before or after the liquid application member 44 is worn.

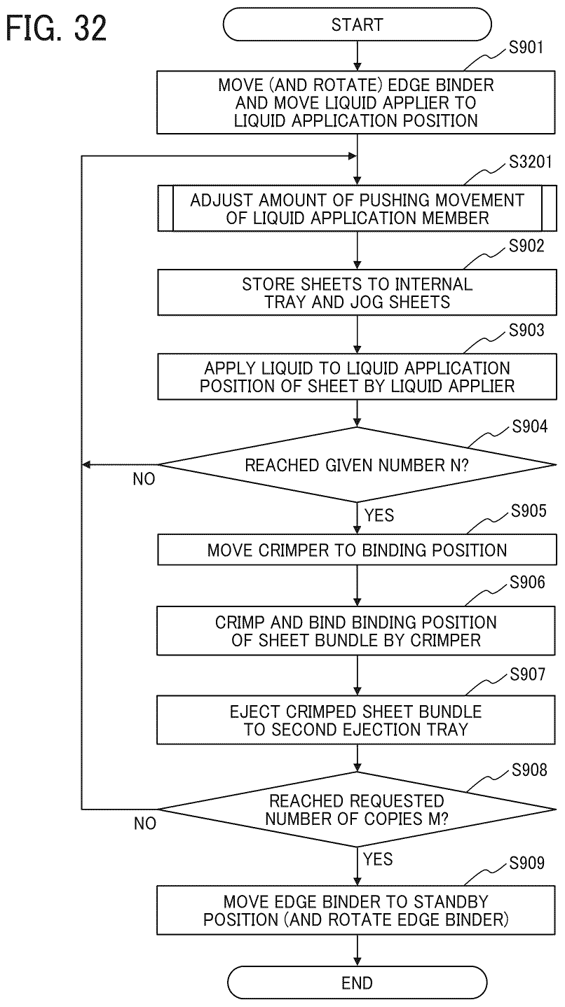

FIG. 32 is a first flowchart of the liquid applying operation according to the fifth example.

In addition to the liquid applying operation described above with reference to FIG. 9, the amount of pushing movement of the liquid application member 44 is adjusted in step S3201. The processes equivalent to the processes described above with reference to FIG. 9 are described in a simplified manner, and processes according to the fifth example are described below in detail.

In step S901, the controller 100b drives the edge-binder movement motor 50 to move the edge binder 25 in the main scanning direction so that the liquid applier 31 faces the first liquid application position B1 instructed by the binding command.

Subsequently, the controller 100b stores the sheet P in the internal tray 22, and in step S3201, adjusts the amount of pushing movement of the liquid application member 44 prior to step S902 where so-called jogging is performed.

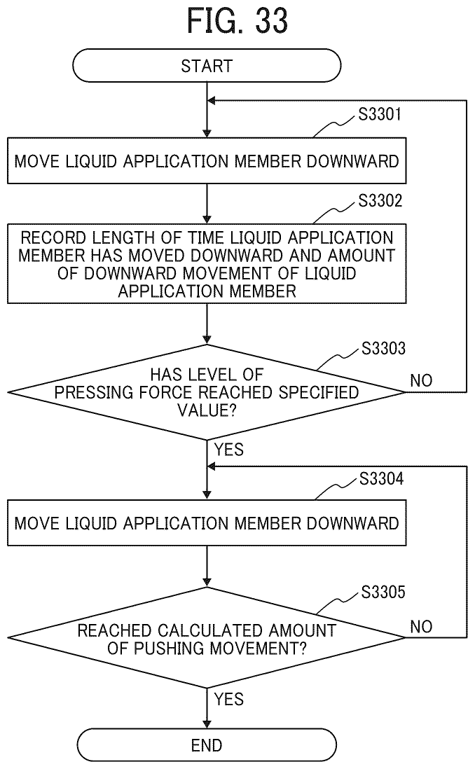

FIG. 33 is a flowchart of the detailed processes of step S3201, according to the fifth example.

In step S3301, the controller 100b lowers the liquid applier or the liquid application member 44 toward the lower pressure plate 33 onto which the sheet P is not yet placed. In step S3302, the recording of the length of time that the liquid application member 44 has moved downward and the amount of downward movement of the liquid application member 44 is continued until it is determined that the level of pressing force detected by the load cell 500 reaches a specified value based on the liquid application control data that is adjusted in advance (NO in step S3303). Until it is determined that the level of pressing force detected by the load cell 500 reaches a specified value based on the liquid application control data that is adjusted in advance, the downward movement of the liquid application member 44 is also continued.

When it is determined that the level of pressing force detected by the load cell 500 has reached a specified value (YES in step S3303), in step S3304, the liquid applier 31 is moved downward. The controller 100b calculates the amount of pushing movement of the liquid application member 44 required to achieve a desired amount of downward movement with reference to the initial value for the standby position, based on the length of time that the liquid application member 44 has moved downward and the amount of downward movement of the liquid application member 44, which were recorded in step S3302.

When it is determined that the liquid application member 44 has not reached the calculated amount of pushing movement (NO in step S3305), the controller 100b pushes the liquid application member 44. When it is determined that the amount of pushing movement of the liquid application member 44 has reached the calculated amount of pushing movement (YES in step S3305), this series of processes for adjusting the amount of pushing movement of the liquid application member 44 is terminated.

Return to FIG. 32. As illustrated in FIG. 32, after the amount of pushing movement of the liquid application member 44 is adjusted in step S3201, the liquid application equivalent to the process in step S902 as described above is performed. The processes in step S903 and the following steps are equivalent to the processes described above with reference to, for example, FIG. 9.

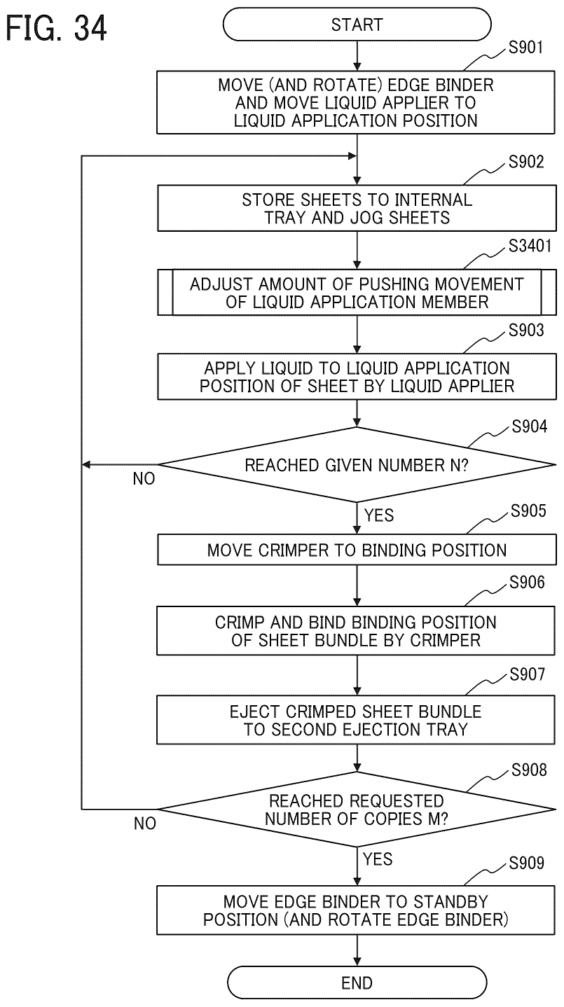

FIG. 34 is a second flowchart of the liquid applying operation according to the fifth example.

In addition to the liquid applying operation described above with reference to FIG. 9, the amount of pushing movement of the liquid application member 44 is adjusted in step S3401. The processes equivalent to the processes described above with reference to FIG. 9 are described in a simplified manner, and processes according to the fifth example are described below in detail.

In step S901, the controller 100b drives the edge-binder movement motor 50 to move the edge binder 25 in the main scanning direction so that the liquid applier 31 faces the first liquid application position B1 instructed by the binding command.

Subsequently, in step S902, the controller 100b stores the sheet P on which the image has been formed by the image forming apparatus 2 in the internal tray 22. In short, the controller 100b performs so-called jogging.

Subsequently, in step S3401, the amount of pushing movement of the liquid application member 44 is adjusted.

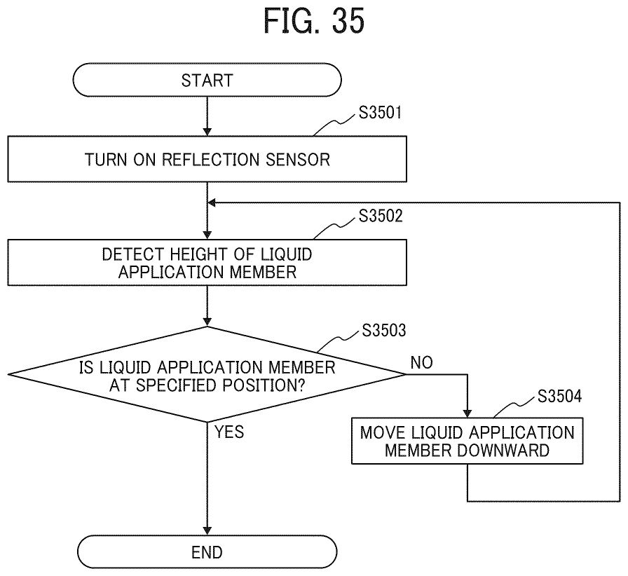

FIG. 35 is a flowchart of the detailed processes of step S3401, according to the fifth example.

In step S3501, the controller 100b activates the reflection sensor 520. At this moment in time, the liquid application member 44 is at a predetermined standby position.

In step S3502, the controller 100b obtains the results of the detection performed by the reflection sensor 520, and in step S3503, the controller 100b determines whether the obtained results of detection are appropriate. When the liquid application member 44 is not at the predetermined position (NO in step S3203), in step S3504, the pushing member 581 is driven to move such that the liquid application member 44 is pushed down and moved downward. When the liquid application member 44 is at a specified position (YES in step S3503), this series of processes for adjusting the amount of pushing movement of the liquid application member 44 is terminated.

Return to FIG. 34. As illustrated in FIG. 34, after the amount of pushing movement of the liquid application member 44 is adjusted in step S3501, the processes in step S903 and the following steps as described above are performed.

### Sixth Example

Technical problems of the liquid applying operation due to wear and tear of the liquid application member 44 are addressed below. Another example is described in which the amount of the liquid applied to the sheet P can be maintained constant.

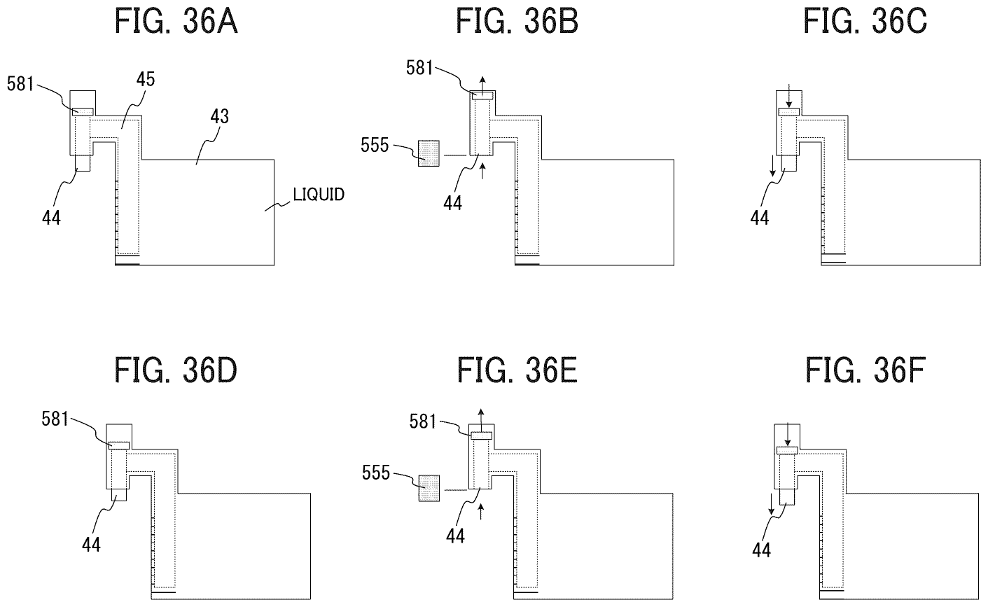

FIG. 36A to FIG. 36F are diagrams illustrating the liquid applier 31 according to a sixth example.

The liquid applier 31 according to the present example has an adjustment mechanism for adjusting the height of the liquid application member 44 to compensate for the amount of wear and tear of the liquid application member 44, and a liquid application member sensor 555 that detects the amount of wear and tear of the liquid application member 44.

FIG. 36A to FIG. 36C illustrate the liquid application member 44 that is not yet worn. FIG. 36D to FIG. 36F illustrate the liquid application member 44 that is worn, according to the sixth example. As illustrated in FIG. 36A to FIG. 36F, the liquid application member sensor 555 is a reflection sensor, and is arranged so as to detect the liquid application member 44 that protrudes from the bottom end of the joints 46. The liquid application member sensor 555 detects whether the end position of the liquid application member 44 that contacts the sheet P is at a specified position or height. Accordingly, when the liquid application member sensor 555 detects the liquid application member 44, the height of the liquid application member 44 is at a specified position.

As illustrated in FIG. 36B or FIG. 36E, the liquid application member sensor 555 is arranged at the front of the first liquid storage tank 43, and detects the position at which the liquid application member 44 is hidden by the first liquid storage tank 43. The pushing member 581 and the liquid application member 44 are fixed together so as to move in conjunction with each other. Accordingly, when the pushing member 581 moves upward, the liquid application member 44 also moves upward. The liquid application member 44 stops moving upward at the position detected by the liquid application member sensor 555. Subsequently, the pushing member 581 is moved downward by a certain degree such that the end of the liquid application member 44 will be at the same position as before the liquid application member 44 is worn. The position at which the liquid application member sensor 555 detects the liquid application member 44 is unchanged before and after the liquid application member 44 is worn, and the liquid application member 44 can be pushed to the same height at either timing. Accordingly, a fixed amount of liquid can be applied to the sheet P.

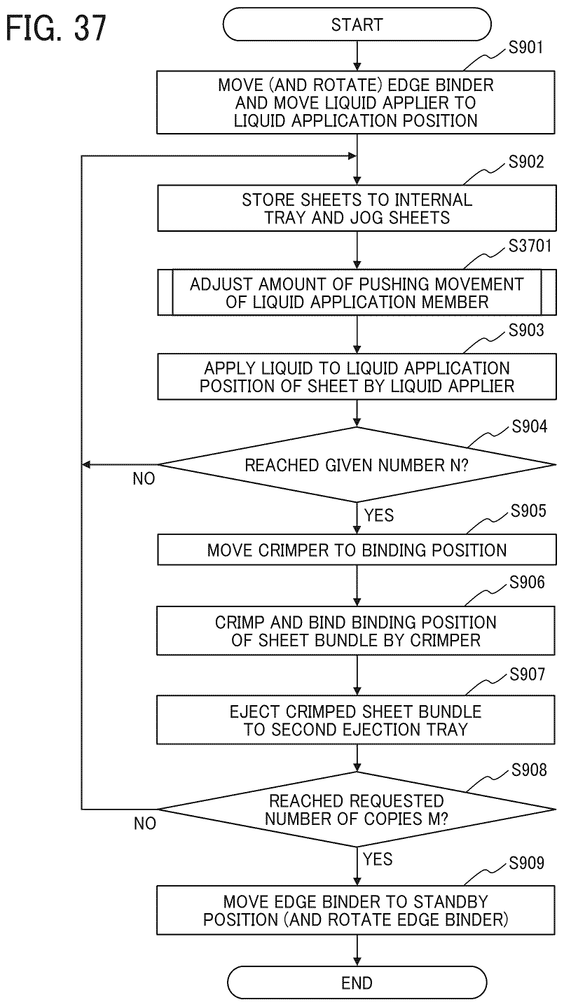

FIG. 37 is a flowchart of the liquid applying operation according to a sixth example.

In addition to the liquid applying operation described above with reference to FIG. 9, the amount of pushing movement of the liquid application member 44 is adjusted in step S3701. The processes equivalent to the processes described above with reference to FIG. 9 are described in a simplified manner, and processes according to the sixth example are described below in detail.

In step S901, the controller 100b drives the edge-binder movement motor 50 to move the edge binder 25 in the main scanning direction so that the liquid applier 31 faces the first liquid application position B1 instructed by the binding command.

Subsequently, in step S902, the controller 100b stores the sheet P on which the image has been formed by the image forming apparatus 2 in the internal tray 22. In short, the controller 100b performs so-called jogging.

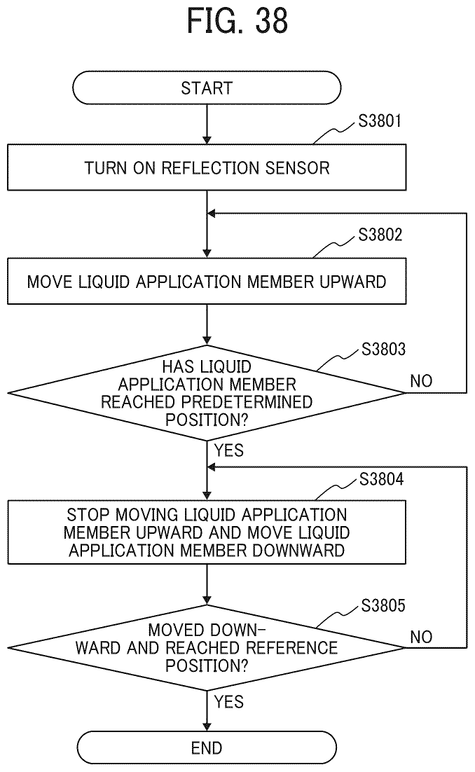

Subsequently, in step S3701, the amount of pushing movement of the liquid application member 44 according to the sixth example is adjusted FIG. 38 is a flowchart of the detailed processes of step S3701, according to the sixth example.

In step S3801, the controller 100b turns on the liquid application member sensor 555. At this moment in time, the liquid application member 44 is at a predetermined standby position.

In step S3802, the controller 100b causes the pushing member 581 to move upward to move the liquid application member 44 upward. In step S3803, the controller 100b cause the liquid application member sensor 555 to detect the liquid application member 44 that is moving upward to determine whether the liquid application member 44 has reached the predetermined position. When the liquid application member 44 reaches the predetermined position, as described above with reference to FIG. 36B or FIG. 36D, the liquid application member 44 is at a reference position and does not stick out from the bottom end of the joint 46. When the liquid application member 44 has not reached the reference position (NO in step S3803), the upward movement of the liquid application member 44 is continued. When the liquid application member 44 reaches the reference position (YES in step S3803), in step S3804, the upward movement of the liquid application member 44 is stopped.

In step S3804, the pushing member 581 is moved downward such that the liquid application member 44 moves downward. It is assumed that the amount of downward movement of the pushing member 581 is determined in advance. In order to handle such a situation, in step S3805, the controller 100b determines whether the amount of downward movement of the pushing member 581 is large enough to move the liquid application member 44 to the reference position.

When the amount of downward movement of the pushing member 581 has not reached a specified amount sufficient for the liquid application member 44 to move to the reference position (NO in step S3805), in step S3804, the pushing member 581 is moved downward such that the liquid application member 44 moves downward. When the amount of downward movement of the pushing member 581 reaches an amount sufficient for the liquid application member 44 to reach the reference position (YES in step S3805), the downward movement of the pushing member 581 is stopped, and this series of processes for adjusting the amount of pushing movement of the liquid application member 44 is terminated. In other words, the end position of the liquid application member 44 is adjusted based on the height data and pressing force so as to be at the same reference position before and after the liquid application member 44 is worn.

Return to FIG. 37. As illustrated in FIG. 37, after the amount of pushing movement of the liquid application member 44 is adjusted in step S3701, the processes in step S903 and the following steps as described above are performed.

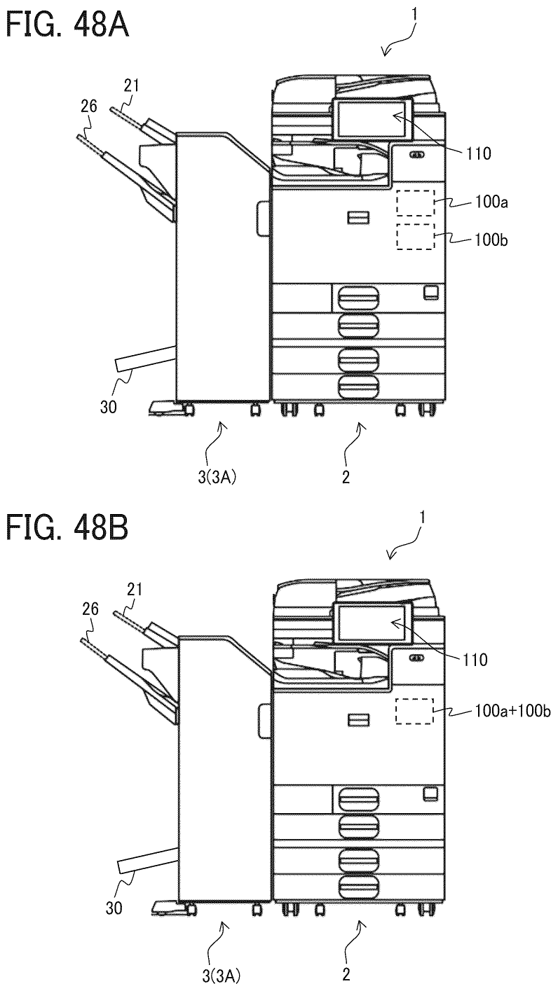

In the above description, the controller 100b of the post-processing apparatus 3 is provided separately from the controller 100a of the image forming apparatus 2 as illustrated in FIG. 1. However, the present disclosure is not limited to the above-described configuration. For example, as illustrated in FIG. 48A, the controller 100b of the post-processing apparatus 3 may be disposed in the image forming apparatus 2. Further, as illustrated in FIG. 48B, the controller 100B of the post-processing apparatus 3 may be integrated with the controller 100A of the image forming apparatus 2.

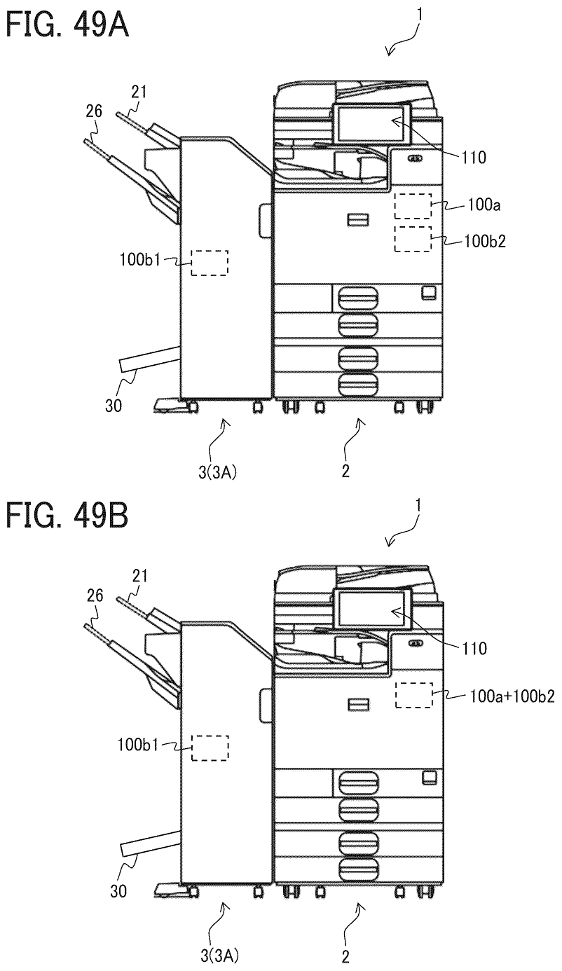

As illustrated in FIG. 49A, the controller 100b of the post-processing apparatus 3 may be divided into a controller 100b1 (e.g., a drive unit such as a motor) and a controller 100b2 (e.g., a sensor) according to the function, and the controller 100b2 of the post-processing apparatus 3 may be disposed in the image forming apparatus 2. Further, as illustrated in FIG. 49B, the controller 100b2 of the post-processing apparatus 3 disposed in the image forming apparatus 2 may be integrated with the controller 100a of the image forming apparatus 2.

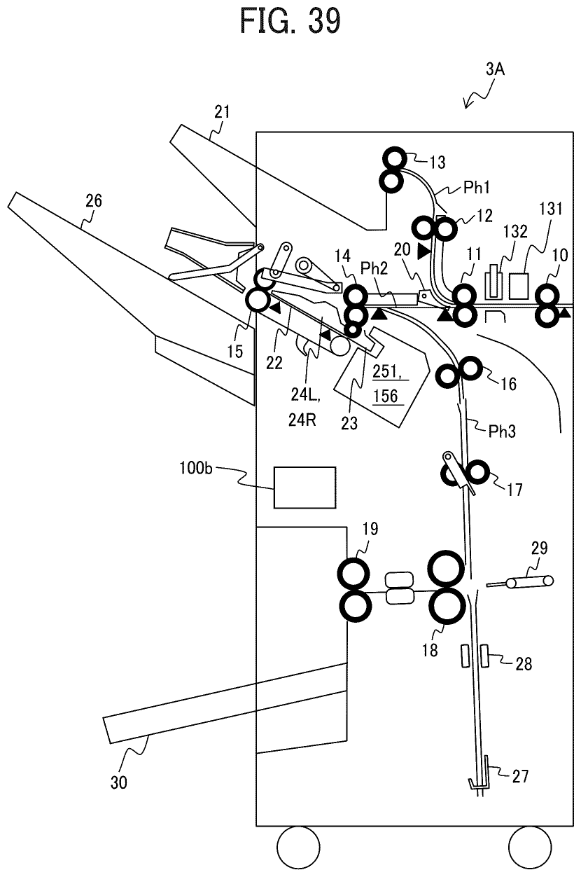

A post-processing apparatus 3A according to a second embodiment is described with reference to FIG. 39 to FIG. 47. In the following description, the same or similar components as those of the post-processing apparatus 3 according to the first embodiment are denoted by the identical or similar reference signs, and redundant descriptions thereof may be omitted.

The post-processing apparatus 3A according to the second embodiment includes an edge binder 251. The edge binder 251 is different from the edge binder 25 of the post-processing apparatus 3 according to the first embodiment, in which the liquid applier 31 and the crimper 32 are arranged side by side, in that the edge binder 251 includes a crimper 32′ and a liquid applier 131 is disposed at an upstream position in a direction in which a sheet P is conveyed. Such a configuration allows a given number of sheets P to be stacked in advance after the liquid application process and conveyed to the crimper 32′ of the edge binder 251 disposed at a downstream position in the direction in which the sheet P is conveyed. Accordingly, the productivity of the binding performed by the crimper 32′ is enhanced.

Since the direction in which the conveyance roller pairs 10, 11, and 14 convey the sheet P is opposite to the “conveyance direction” defined above, the direction in which the conveyance roller pairs 10, 11, and 14 convey the sheet P is defined as an “opposite conveyance direction” in the following description. A direction that is orthogonal to both the reverse conveyance direction and the thickness direction of the sheet P is defined as the “main scanning direction” or the “width direction of the sheet P.”

The liquid application position to which the liquid is applied on the sheet P or the sheet bundle Pb by the liquid applier 131 corresponds to the binding position on the sheet bundle Pb to be crimped and bound by the crimper 32′. For this reason, in the following description, the liquid application position and the binding position are described with the same reference sign.

FIG. 39 is a diagram illustrating an internal structure of the post-processing apparatus 3A according to the second embodiment.

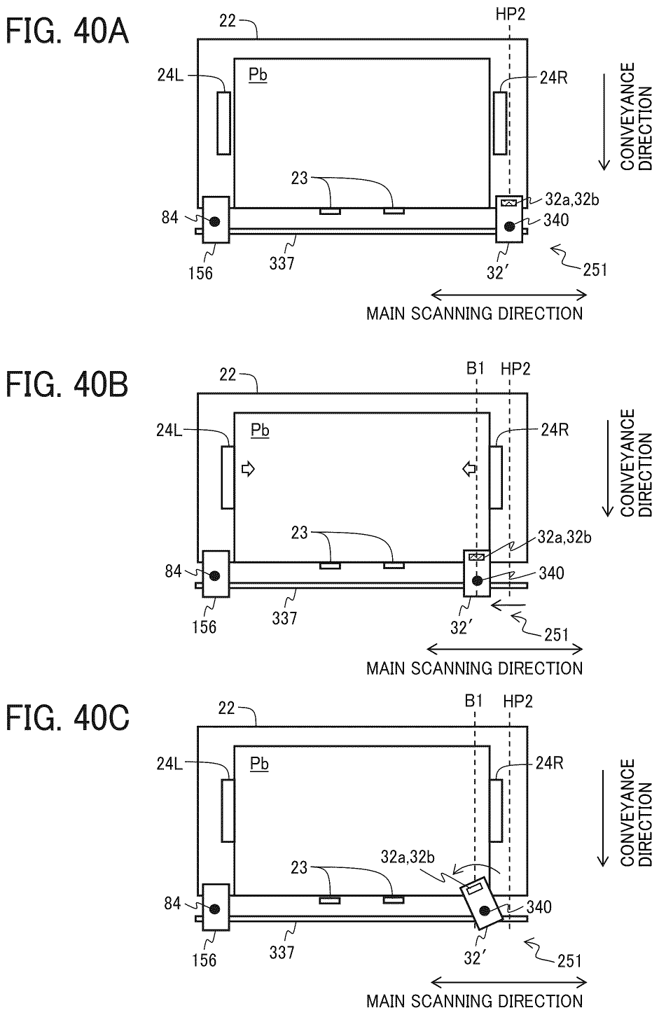

As illustrated in FIG. 40A to FIG. 40C, the edge binder 251 includes the crimper 32′. As illustrated in FIG. 40A to FIG. 40C, the crimper 32′ and the staple binder 156 are disposed downstream from the internal tray 22 in the conveyance direction. In addition, the crimper 32′ and the staple binder 156 are located to face a downstream end, in the conveyance direction, of the sheet bundle Pb placed on the internal tray 22 and is movable in the main scanning direction.

Further, the crimper 32′ and the staple binder 156 are rotatable in both forward and reverse directions about a crimper shaft 340 and a stapler shaft 84 both extending in the thickness direction of the sheet bundle Pb placed on the internal tray 22. In other words, the crimper 32′ and the staple binder 156 bind, at a desired angle, any desired position in the main scanning direction on the sheet bundle Pb placed on the internal tray 22 in, for example, corner oblique binding, parallel one-point binding, or parallel two-point binding.

The crimper 32′ presses and deforms the sheet bundle Pb with the serrate upper crimping teeth 32a and the serrate lower crimping teeth 32b to bind the sheet bundle Pb. In the following description, such a binding way may be referred to as “crimping.” In other words, the crimper 32′ crimps and binds the sheet bundle Pb or performs the crimping on the sheet bundle Pb. On the other hand, the staple binder 156 passes the staple through a binding position on the sheet bundle Pb placed on the internal tray 22, thus allowing the sheet bundle Pb to be stapled.

FIG. 40A to FIG. 40C are schematic diagrams of the internal tray 22 viewed in the thickness direction of the sheet bundle Pb.

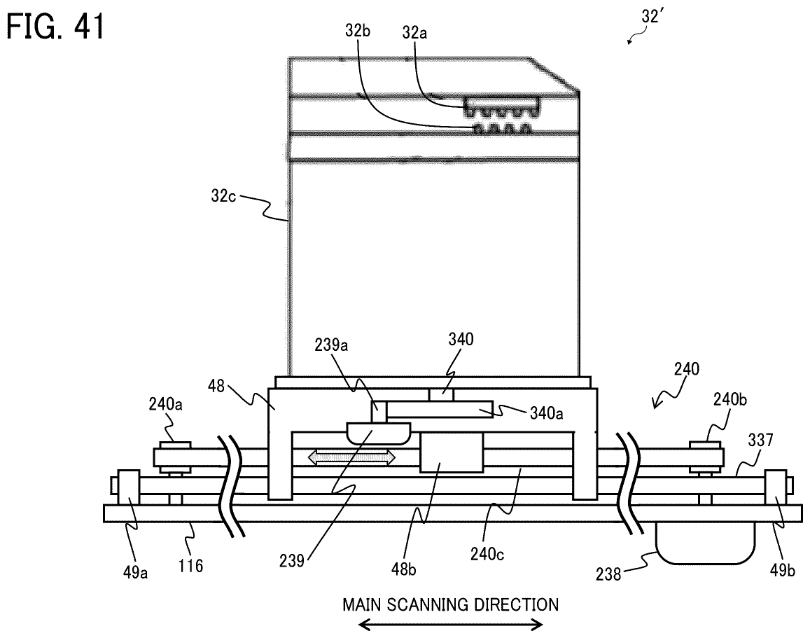

FIG. 41 is a schematic diagram of the crimper 32′ viewed from the downstream side in the conveyance direction.

As illustrated in FIG. 40A to FIG. 40C, the crimper 32′ and the staple binder 156 are disposed downstream from the internal tray 22 in the conveyance direction. The crimper 32′ is movable in the main scanning direction along the surface of the sheet bundle Pb placed on the internal tray 22. Further, the crimper 32′ is rotatable in both forward and reverse directions about a crimper shaft 340 extending in the thickness direction of the sheet bundle Pb placed on the internal tray 22.

In a similar manner to the above, the staple binder 156 is movable in the main scanning direction of the sheet bundle Pb. Further, the staple binder 156 is rotatable in both forward and reverse directions about a stapler shaft 84 extending in thickness direction of the sheet bundle Pb. The other configurations of the staple binder 156 are equivalent to those of the staple binder 55 of the post-processing apparatus 3 according to the first embodiment (see FIG. 6).

As illustrated in FIG. 41, the crimper 32′ includes a guide rail 337 extending in the main scanning direction at a position downstream from the internal tray 22 in the conveyance direction. The crimper 32′ includes a crimper movement motor 238 as a driving source. A base 48 supporting a crimper frame 32c has a fastening portion 48b for a timing belt 240c at the bottom of the base 48. The driving force of the crimper movement motor 238 is transmitted to the base 48 by the drive transmission assembly 240 that includes the pulleys 240a and 240b, the timing belt 240c, and the fastening portion 48b. By so doing, the crimper 32′ is moved in the main scanning direction along the surface of the sheet bundle Pb placed on the internal tray 22, in other words, along the guide rail 337. The crimper shaft 340 including a drive transmission gear 340a is fixed to a bottom face of the crimper frame 32c that holds the components of the crimper 32′.

The crimper shaft 340 and the drive transmission gear 340a are held by a base 48 on which the crimper frame 32c is disposed, so as to be rotatable in both forward and reverse directions. The drive transmission gear 340a meshes with an output gear 239a of a crimper pivot motor 239. When the driving force of the crimper pivot motor 239 is transmitted to the crimper shaft 340 via the output gear 239a and the drive transmission gear 340a, the crimper 32′ rotates in both forward and reverse directions on the base 48 about the crimper shaft 340 extending in the thickness direction of the sheet P placed on the internal tray 22. The guide rail 337, the crimper movement motor 238, the crimper pivot motor 239, the crimper shaft 340, and the drive transmission assembly 240 constitute at least part of an example of a driving assembly of the crimper 32′.

The crimper 32′ is movable between a standby position HP2 illustrated in FIG. 40A and a position where the crimper 32′ faces the first binding position B1 illustrated in FIG. 40B and FIG. 40C. The standby position HP2 is a position away in the main scanning direction from the sheet bundle Pb placed on the internal tray 22. The first binding position B1 is a position on the sheet bundle Pb placed on the internal tray 22. However, the specific position of the first binding position B1 is not limited to the position illustrated in FIG. 40A to FIG. 40C. The first binding position B1 may be one or more positions along the main scanning direction at the downstream end, in the conveyance direction, of the sheet P.

The posture of the crimper 32′ changes or is pivoted between a parallel binding posture illustrated in FIG. 40B and an oblique binding posture illustrated in FIG. 40C. In other words, the crimper 32′ is rotatable in both forward and reverse directions about the crimper shaft 340. The parallel binding posture is a posture of the crimper 32′ in which the length of the upper crimping teeth 32a and the lower crimping teeth 32b (in other words, a rectangular crimp binding trace) is along the main scanning direction. The oblique binding posture is a posture of the crimper 32′ in which the longer-side direction of the upper crimping teeth 32a and the lower crimping teeth 32b (i.e., the rectangular crimping trace) is inclined with respect to the main scanning direction.

The pivot angle in the inclined binding posture, which an angle of the upper crimping teeth 32a and the lower crimping teeth 32b with respect to the main scanning direction, is not limited to the example of FIG. 40C, and may be any angle provided that the upper crimping teeth 32a and the lower crimping teeth 32b face the sheet bundle Pb placed on the internal tray 22.

The post-processing apparatus 3A includes the liquid applier 131 and a hole punch 132, which is an example of a processor. The liquid applier 131 and the hole punch 132 are disposed upstream from the internal tray 22 in the opposite conveyance direction. Moreover, the liquid applier 131 and the hole punch 132 are disposed at different positions in the reverse conveyance direction to simultaneously face one sheet P that is conveyed by the conveyance roller pairs 10 to 19.

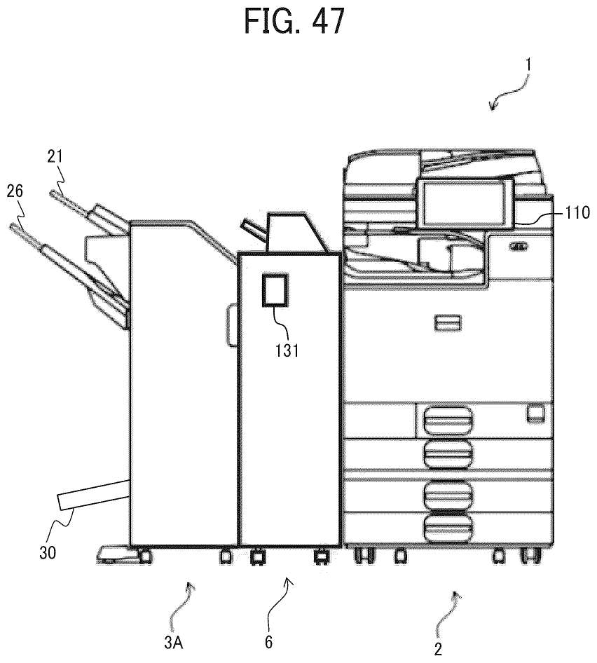

The liquid applier 131 and the hole punch 132 according to the present embodiment are disposed between the conveyance roller pairs 10 and 11. However, the arrangement of the liquid applier 131 is not limited to the example described above with reference to FIG. 39. For example, in a case where an inserter 6 is disposed between the image forming apparatus 2 and the post-processing apparatus 3A as illustrated in FIG. 47, the liquid applier 131 may be disposed inside the inserter 6 located upstream from the post-processing apparatus 3A in a direction in which the sheet P is conveyed from the image forming apparatus 2 to the post-processing apparatus 3A. Examples of the inserter 6 include, but are not limited to, an apparatus that allows a pre-printed medium, which is to be conveyed to the post-processing apparatus 3A together with the sheet P conveyed from the image forming apparatus 2, to be fed as a cover sheet, an insertion sheet, or a partition sheet without passing through the image forming apparatus 2.

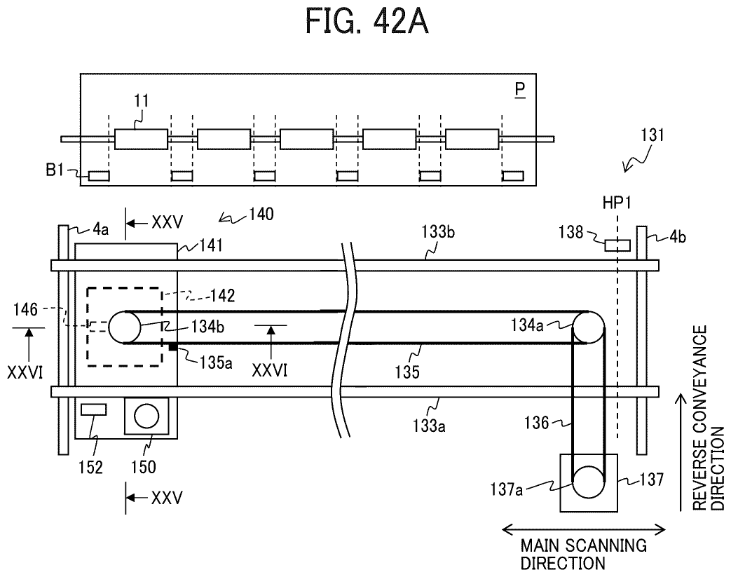

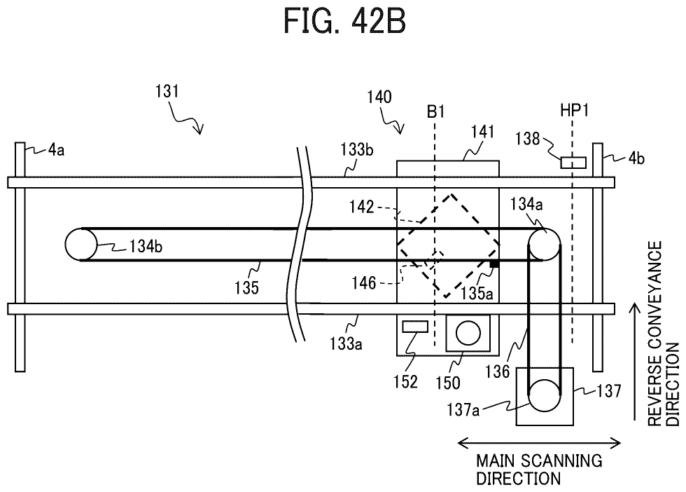

As illustrated in FIG. 42A, the conveyance roller pair 11 is located so as not to overlap, in the main scanning direction, the first liquid application position B1 on the sheet P to which the liquid has been applied by a liquid application head 146 of the liquid applier 131. This arrangement is to prevent the amount of liquid at the first liquid application position B1 from decreasing due to the multiple roller pairs pressing the first liquid application position B1 when the conveyance roller pair 11 conveys the sheet P. As a result, when the sheet P reaches the crimper 32′ disposed downstream from the liquid applier 131 in the opposite conveyance direction, the amount of liquid at the first liquid application position B1 is sufficient to maintain the binding strength. Accordingly, the binding strength of the sheet bundle Pb is prevented from decreasing due to a decrease in the amount of liquid at the first liquid application position B1 (corresponding to the first binding position B1) while the sheet P is conveyed.

In addition, the multiple roller pairs of the conveyance roller pair 11 that is located so as not to overlap the first liquid application position B1 on the sheet P in the main scanning direction prevents the conveying performance of the sheet P from being worse due to the adhesion of liquid to the multiple roller pairs and further prevents a conveyance jam caused by the worsened conveying performance of the sheet P.

Although only the conveyance roller pair 11 has been described above, the multiple roller pairs of the conveyance roller pairs 14 and 15 are preferably located so as not to overlap the first liquid application position B1 on the sheet P in the main scanning direction, like the multiple roller pairs of the conveyance roller pair 11.

The liquid applier 131 applies liquid to the sheet P that is conveyed by the conveyance roller pairs 10 and 11. In the following description, the application of liquid may be referred to as “liquid application.” The hole punch 132 punches a hole in the sheet P that is conveyed by the conveyance roller pairs 10 and 11 such that the hole penetrates the sheet P in the thickness direction of the sheet P. The processor disposed near the liquid applier 131 is not limited to the hole punch 132.

Alternatively, the processor may be an inclination corrector that corrects an inclination or skew of the sheet P that is conveyed by the conveyance roller pairs 10 and 11.

FIG. 42A and FIG. 42B are schematic diagrams of the liquid applier 131 viewed in the thickness direction of the sheet P, according to the second embodiment.

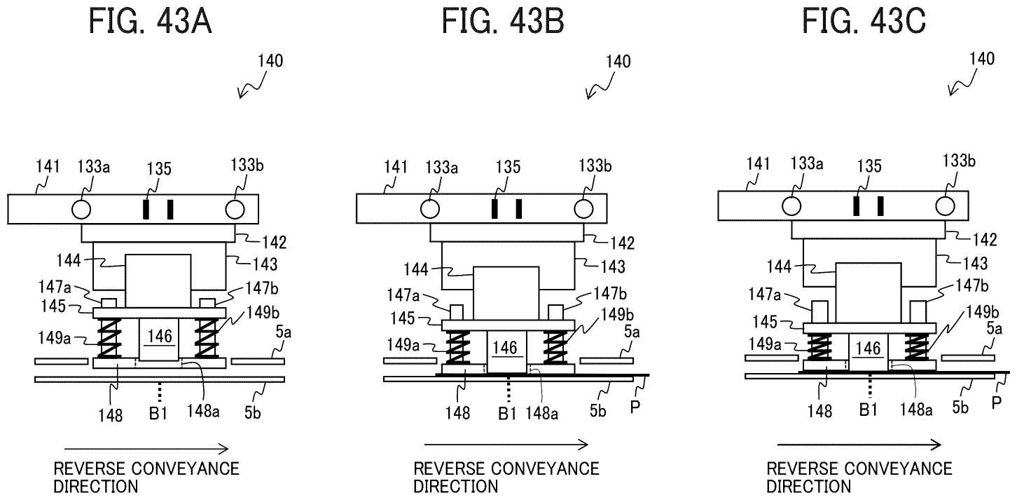

FIG. 43A to FIG. 43C are sectional views of the liquid applier 131 taken along a line XXV-XXV of FIG. 42A.

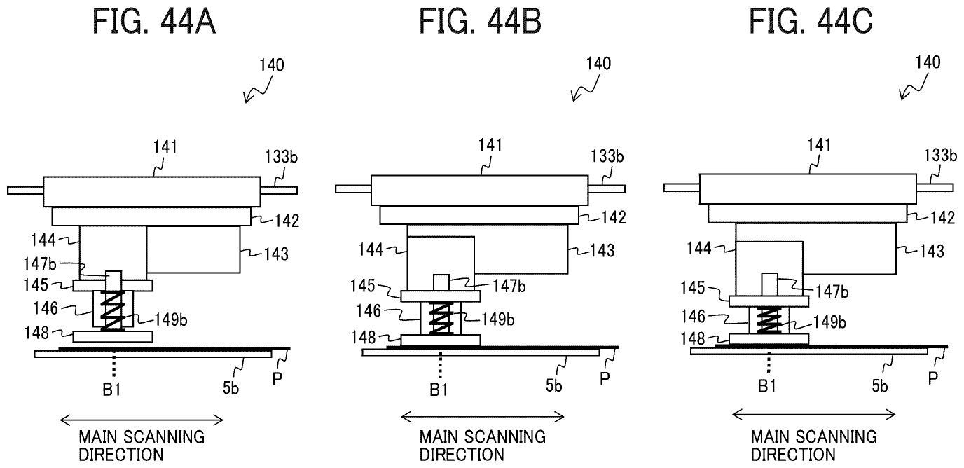

FIG. 44A to FIG. 44C are sectional views of the liquid applier 131 taken along a line XXVI-XXVI of FIG. 42A.

As illustrated in FIG. 42A to FIG. 44C, the liquid applier 131 includes a pair of guide shafts 133a and 133b, a pair of pulleys 134a and 134b, annular seamless belts 135 and 136, a liquid-applier movement motor 137, a standby position sensor 138, and the liquid application unit 140.

The pair of guide shafts 133a and 133b each extend in the main scanning direction at positions spaced apart from each other in the opposite conveyance direction. The pair of guide shafts 133a and 133b are supported by a pair of side plates 4a and 4b of the post-processing apparatus 3A. The pair of guide shafts 133a and 133b support the liquid application unit 140 such that the liquid application unit 140 can move in the main scanning direction.

The pair of pulleys 134a and 134b is disposed between the guide shafts 133a and 133b in the opposite conveyance direction. Moreover, the pair of pulleys 134a and 134b are spaced from each other in the main scanning direction. The pair of pulleys 134a and 134b are supported by a frame of the post-processing apparatus 3A so as to be rotatable in both forward and reverse directions about the respective rotary shafts extending in the thickness direction of the sheet P.

The annular seamless belt 135 is looped around the pair of pulleys 134a and 134b. The annular seamless belt 135 is coupled to the liquid application unit 140 by a connection 135a. The annular seamless belt 136 is entrained around the pulley 134a and a driving pulley 137a that is fixed to an output shaft of the liquid-applier movement motor 137. The liquid-applier movement motor 137 generates a driving force to move the liquid application unit 140 in the main scanning direction.

As the liquid-applier movement motor 137 rotates, the annular seamless belt 136 circulates around the pulley 134a and the driving pulley 137a to rotate the pulley 134a. As the pulley 134a rotates, the annular seamless belt 135 circulates around the pair of pulleys 134a and 134b. Thus, the liquid application unit 140 moves in the main scanning direction along the pair of guide shafts 133a and 133b. The liquid application unit 140 reciprocates in the main scanning direction in response to the rotation direction of the liquid-applier movement motor 137 being switched.

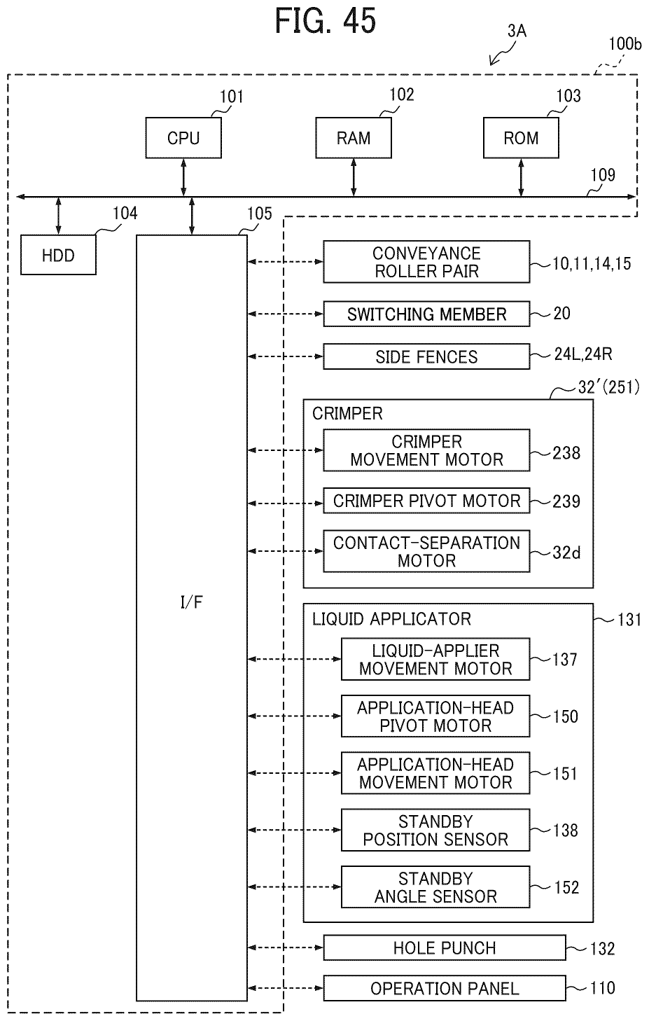

The standby position sensor 138 detects that the liquid application unit 140 has reached a standby position HP1 (see FIG. 42A and FIG. 42B) in the main scanning direction. The standby position sensor 138 then outputs a standby position signal indicating the detection result to the controller 100b, which will be described below with reference to FIG. 45. The standby position sensor 138 is, for example, an optical sensor including a light emitter and a light receiver. At the standby position HP1, the liquid application unit 140 blocks the optical path between the light emitter and the light receiver. The standby position sensor 138 outputs the standby position signal in response to the light output from the light emitter not being received by the light receiver. The specific configuration of the standby position sensor 138 is not limited to the configuration described above.

As illustrated in FIG. 43A to FIG. 43C, the conveyance path inside the post-processing apparatus 3A is defined by an upper guide plate 5a and a lower guide plate 5b, which are apart from each other in the thickness direction of the sheet P. The liquid application unit 140 is located to face an opening of the upper guide plate 5a. In other words, the liquid application unit 140 is disposed to face the conveyance path (a position at which the liquid application unit 140 can face the sheet P) through the opening of the upper guide plate 5a.

As illustrated in FIG. 42A to FIG. 44C, the liquid application unit 140 includes a base 141, a rotary bracket 142, a liquid storage tank 143, a liquid-application-head mover 144, a holder 145, the liquid application head 146, columns 147a and 147b, a pressure plate 148, coil springs 149a and 149b, the application-head pivot motor 150, the application-head movement motor 151 (see FIG. 45), and a standby angle sensor 152 (see FIG. 45).

The base 141 is supported by the pair of guide shafts 133a and 133b so as to be slidable in the main scanning direction. The base 141 is coupled to the annular seamless belt 135 by the connection 135a. The base 141 supports the components 142 to 152 of the liquid application unit 140.

The rotary bracket 142 is attached to the lower face of the base 141 so as to be rotatable in both forward and reverse directions about a rotary shaft extending in the thickness direction of the sheet P. The rotary bracket 142 is rotated in both forward and reverse directions with respect to the base 141 by the driving force transmitted from the application-head pivot motor 150. The rotary bracket 142 retains the liquid storage tank 143, the liquid-application-head mover 144, the holder 145, the liquid application head 146, the columns 147a and 147b, the pressure plate 148, and the coil springs 149a and 149b.

The standby angle sensor 152, which is also illustrated in FIG. 45, detects that the rotary bracket 142 has reached a standby angle. The standby angle sensor 152 then outputs a standby angle signal indicating the detection result to the controller 100b. The standby angle is, for example, an angle at the time of performing parallel binding. The standby angle sensor 152 is, for example, an optical sensor including a light emitter and a light receiver. The rotary bracket 142 at the standby angle blocks an optical path between the light emitter and the light receiver. The standby angle sensor 152 outputs the standby angle signal in response to the light output from the light emitter not being received by the light receiver. However, the specific configuration of the standby angle sensor 152 is not limited to the above-described example.

FIG. 42A illustrates the rotary bracket 142 in a position for the parallel binding that is performed by the crimper 32′ disposed downstream from the liquid applier 131 in a direction in which the sheet P is conveyed. FIG. 42B illustrates the rotary bracket 142 in a position for the oblique binding (i.e., corner binding) that is performed by the crimper 32′ disposed downstream from the liquid applier 131 in the direction in which the sheet P is conveyed.

The liquid storage tank 143 stores liquid to be applied to the sheet P. The liquid-application-head mover 144 is attached to the liquid storage tank 143 so as to be movable (e.g., up and down) in the thickness direction of the sheet P. The liquid-application-head mover 144 moves with respect to the liquid storage tank 143 by a driving force transmitted from the application-head movement motor 151. The holder 145 is attached to a lower end of the liquid-application-head mover 144. The liquid application head 146 projects from the holder 145 toward the conveyance path. The liquid application head 146 projects downward in the present embodiment. The liquid that is stored in the liquid storage tank 143 is supplied to the liquid application head 146. The liquid application head 146 is made of a material having a high liquid absorption (e.g., sponge or fiber).

The columns 147a and 147b project downward from the holder 145 around the liquid application head 146. The columns 147a and 147b can be moved relative to the holder 145 relatively in the thickness direction. The columns 147a and 147b hold the pressure plate 148 at lower ends thereof. The pressure plate 148 has a through hole 148a at a position to face the liquid application head 146. The coil springs 149a and 149b are inserted to the outsides of the columns 147a and 147b between the holder 145 and the pressure plate 148. The coil springs 149a and 149b bias the columns 147a and 147b and the pressure plate 148 downward with respect to the holder 145.

As illustrated in FIG. 43A and FIG. 44A, at the stage before the sheet P is conveyed to the position where the sheet P faces the opening of the upper guide plate 5a, the pressure plate 148 is positioned at or above the opening. Subsequently, when the sheet P that is conveyed by the conveyance roller pairs 10 and 11 stops at a position where the first liquid application position B1 on the sheet P faces the opening, the application-head movement motor 151 is rotated in a first direction. As a result, the liquid-application-head mover 144, the holder 145, the liquid application head 146, the columns 147a and 147b, the pressure plate 148, and the coil springs 149a and 149b move down together, and the pressure plate 148 contacts the sheet P. The first liquid application position B1 corresponds to the first binding position B1 to be crimped and bound by the edge binder 251, specifically, the crimper 32′.

As the application-head movement motor 151 keeps rotating in the first direction even after the pressure plate 148 contacts the sheet P, the coil springs 149a and 149b are compressed to move the liquid-application-head mover 144, the holder 145, the liquid application head 146, and the columns 147a and 147b further downward. As illustrated in FIG. 43B and FIG. 44B, a lower face of the liquid application head 146 contacts the sheet P through the through hole 148a. As a result, the liquid contained in the liquid application head 146 is applied to the sheet P.

Further, as described above with reference to FIG. 43C and FIG. 44C, the application-head movement motor 151 is further rotated in the first direction, and the liquid application head 146 can be further strongly pressed against the sheet P. Accordingly, the amount of liquid applied to the sheet P increases. In short, the liquid applier 131 changes the pressing force of the liquid application head 146 against the sheet P to adjust the amount of liquid that is applied to the sheet P.

On the other hand, the rotation of the application-head movement motor 151 in the second direction opposite to the first direction moves up the liquid-application-head mover 144, the holder 145, the liquid application head 146, the columns 147a and 147b, the pressure plate 148, and the coil springs 149a and 149b together. As a result, as illustrated in FIG. 43A and FIG. 44A, the liquid application head 146 and the pressure plate 148 move away from the sheet P. In other words, the liquid applier 131 includes the liquid application head 146 that can be separated from the sheet P.

FIG. 45 is a block diagram illustrating a hardware configuration of the post-processing apparatus 3A to control the operation of the post-processing apparatus 3A according to the second embodiment.

As illustrated in FIG. 45, the post-processing apparatus 3A includes a central processing unit (CPU) 101, a random-access memory (RAM) 102, a read-only memory (ROM) 103, a hard disk drive (HDD) 104, and an interface (interface) 105 that are connected to each other through a common bus 109.

The CPU 101 is an arithmetic device and controls the overall operation of the post-processing apparatus 3A. The RAM 102 is a volatile storage medium that allows high speed reading and writing of information, and is used as a working area when the CPU 101 processes information. The ROM 103 is a read-only non-volatile storage medium, and stores programs such as firmware. The HDD 104 is a nonvolatile data readable/writable memory and has a relatively large storage capacity. The HDD 104 stores, for example, an operating system (OS), various kinds of control programs, and application programs.

By an arithmetic function of the CPU 101, the post-processing apparatus 3A processes, for example, a control program stored in the ROM 103 and an information processing program (application program) loaded into the RAM 102 from a storage medium such as the HDD 104. With such processing, a software controller including various functional modules of the post-processing apparatus 3A is configured. The software controller thus configured is combined with hardware resources of the post-processing apparatus 3A mounted in the post-processing apparatus 3A to configure functional blocks that implement functions of the post-processing apparatus 3A. In other words, the CPU 101, the RAM 102, the ROM 103, the HDD 104, and the interface 105 constitute at least part of a controller 100b serving as a control device that controls the operation of the post-processing apparatus 3A.

The interface 105 is an interface that connects the conveyance roller pairs 10, 11, 14, and 15, the switching member 20, the side fences 24L and 24R, the crimper movement motor 238, the crimper pivot motor 239, a contact-separation motor 32d, a liquid-applier movement motor 137, an application-head pivot motor 150, an application-head movement motor 151, a standby position sensor 138, a standby angle sensor 152, a hole punch 132, and an operation panel 110 to the common bus 109.

The controller 100b controls, via the interface 105, the operations of the conveyance roller pairs 10, 11, 14, and 15, the switching member 20, the side fences 24L and 24R, the crimper movement motor 238, the crimper pivot motor 239, the contact-separation motor 32d, the liquid-applier movement motor 137, the application-head pivot motor 150, the application-head movement motor 151, and the hole punch 132. The controller 100b acquires detection results from the standby position sensor 138 and the standby angle sensor 152 through the interface 105.

Although FIG. 45 illustrates the components of the liquid applier 131 and the edge binder 251 (the crimper 32′) that executes the edge binding, the components of the saddle binder 28 that executes the saddle binding are controlled by the controller 100b like the components of the liquid applier 131 and the edge binder 251 (the crimper 32′) that executes the edge binding.

As illustrated in FIG. 47, the image forming apparatus 2 includes the operation panel 110. The operation panel 110 includes an operation section that receives instructions input by an operator and a display (which is an example of a notifier) that notifies the operator of information. The operation section includes, for example, hard keys and a touch screen overlaid on the display. The operation panel 110 acquires information from the user through the operation device and provides information to the user through the display. The post-processing apparatus 3A may include an operation panel 110 similar to the above-described operation panel 110 of the image forming apparatus 2.

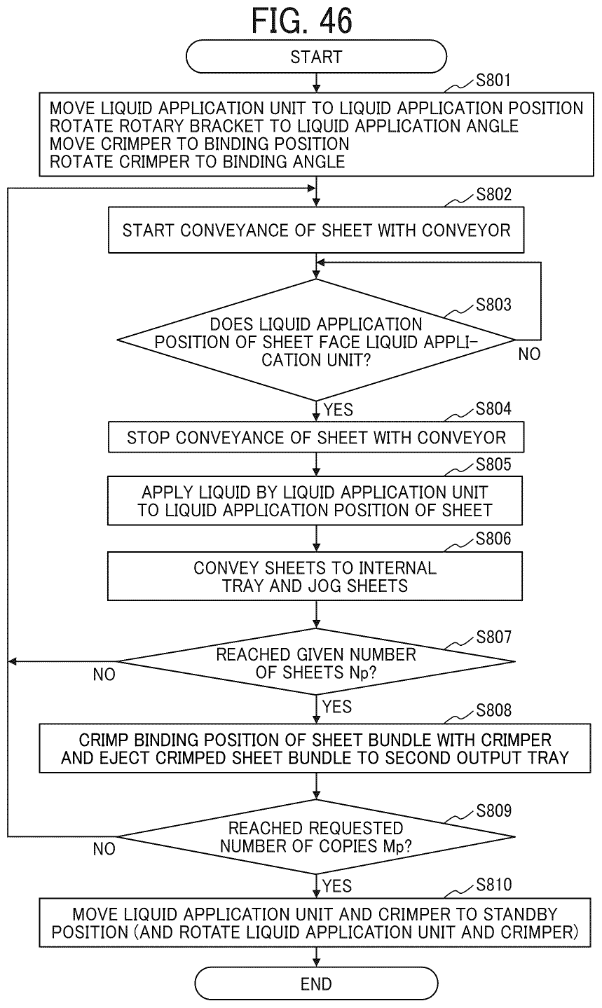

FIG. 46 is a flowchart of post-processing performed by the post-processing apparatus 3A according to the second embodiment.

More specifically, FIG. 46 is a flowchart of a process to execute the one-point binding illustrated in FIG. 40A to FIG. 40C.

For example, the controller 100b executes the post-processing illustrated in FIG. 46 in response to acquisition of an instruction (denoted below as “post-processing command”) of executing the post-processing from the image forming apparatus 2. The post-processing command includes, for example, the number of sheets P of the sheet bundle Pb, which may be referred to as a given number of sheets Np in the following description), the number of sheet bundles Pb to be subjected to binding, the first binding position B1 (corresponding to the first liquid application position B1), the angle of the first binding position B1 (corresponding to the angle of the first liquid application position B1), the type of binding (parallel binding or oblique binding), and a process that is executed in parallel with the liquid application process (i.e., punching a hole in the present embodiment). In the following description, the number of sheets P of the sheet bundle Pb may be referred to as a given number of sheets Np, and the number of sheet bundles Pb to be subjected to binding may be referred to as a requested number of copies Mp. At the start of the post-processing, the liquid application unit 140 is at the standby position HP1 illustrated in FIG. 42A and FIG. 42B, and the rotary bracket 142 is held at the standby angle (corresponding to the parallel binding posture) at the standby position HP1.

First, the controller 100b drives the liquid-applier movement motor 137 to move the liquid application unit 140, which corresponds to the liquid applier, in the main scanning direction, thus causing the liquid application head 146 to move from the standby position HP1 to the position where the liquid application head 146 can face the first liquid application position B1 (see FIG. 42B for the position corresponding to the first binding position B1 illustrated in FIG. 40B and FIG. 40C). If the type of the binding instructed by the post-processing command is oblique binding, in step S801, the controller 100b drives the application-head pivot motor 150 to rotate the rotary bracket 142. Thus, the liquid application head 146 is rotated from the standby angle to the liquid application angle corresponding to the “oblique binding posture.” It can be ascertained, based on pulse signals output from rotary encoders of the liquid-applier movement motor 137 and the application-head pivot motor 150, that the liquid application head 146 has reached the position where the liquid application head 146 can face the first liquid application position B1. If the type of the binding instructed by the post-processing command is parallel binding, the controller 100b omits the above-described operation of rotating the rotary bracket 142. In other words, the liquid application unit 140 moves in the main scanning direction while holding the rotary bracket 142 at the standby angle.

Further, in step S801, the controller 100b drives the crimper movement motor 238 to move the crimper 32′ from the standby position HP2 to the position where the crimper 32′ can face the first binding position B1 as illustrated in FIG. 40A and FIG. 40B. Alternatively, if the type of the binding instructed by the post-processing command is oblique binding, in step S801, the controller 100b drives the crimper pivot motor 239 to rotate the crimper 32′ from the standby angle to the crimping angle corresponding to the oblique binding posture. It is ascertained based on a pulse signal output from a rotary encoder of the crimper movement motor 238 that the crimper 32 has reached the position where the crimper 32 can face the first binding position B1. In a similar manner, it is ascertained based on a pulse signal output from a rotary encoder of the crimper pivot motor 239 that the crimper 32 has reached the crimp binding angle. If the type of the binding instructed by the post-processing command is parallel binding, the controller 100b omits the above-described operation of rotating the crimper 32′. In other words, the crimper 32′ moves in the main scanning direction while maintaining the standby angle.

Subsequently, in step S802, the controller 100b drives the conveyance roller pairs 10 and 11 to start conveying the sheet P on which an image is formed by the image forming apparatus 2. In step S803, the controller 100b determines whether the first liquid application position B1 on the sheet P faces first the liquid application unit 140 (more specifically, the liquid application head 146). In other words, the controller 100b determines whether the liquid application unit 140 has faced the first liquid application position B1 on the sheet P. When the first liquid application position B1 on the sheet P has not faced the liquid application unit 140 (NO in step S803), the controller 100b repeats the processing in step S803. In other words, the controller 100b continues driving the conveyance roller pairs 10 and 11 until the first liquid application position B1 on the sheet P faces the liquid application head 146 (YES in step S803). When the controller 100b determines that the first liquid application position B1 on the sheet P has faced the liquid application head 146 (YES in step S803), in step S804, the controller 100b causes the conveyance roller pairs 10 and 11 to stop conveying the sheet P. It is ascertained, based on a pulse signal output from a rotary encoder of a motor that drives the conveyance roller pairs 10 and 11, that the first liquid application position B1 on the sheet P has faced the liquid application head 146.

In step S805, the controller 100b causes the liquid application unit 140 to execute the process of applying liquid to the first liquid application position B1 on the sheet P. More specifically, the controller 100b rotates the application-head movement motor 151 in the first direction to bring the liquid application head 146 into contact with the first liquid application position B1 on the sheet P. The controller 100b changes the pressing force of the liquid application head 146 (i.e., the amount of rotation of the application-head movement motor 151) depending on the amount of liquid to be applied to the sheet P.

The amount of liquid that is applied to the sheet P may be the same for all the sheets P of the sheet bundle Pb or may be different for each sheet P. For example, the controller 100b may decrease the amount of liquid applied to a sheet P conveyed later. The amount of rotation of the application-head movement motor 151 can be ascertained based on a pulse signal output from a rotary encoder of the application-head movement motor 151.

In step S806, the controller 100b drives the conveyance roller pairs 10, 11, 14, and 15 to place a sheet P on the internal tray 22. In step S806, the controller 100b also moves the side fences 24L and 24R in the main scanning direction to align the position of the sheet P or the sheet bundle Pb placed on the internal tray 22 in the main scanning direction. In short, the controller 100b performs so-called jogging.

In step S807, the controller 100b determines whether the number of sheets P placed on the internal tray 22 has reached the given number of sheets Np indicated by the post-processing command. When the controller 100b determines that the number of sheets P placed on the internal tray 22 has not reached the given number of sheets Np (NO in step S807), the controller 100b repeats the operations of steps S802 to S807 until the number of sheets P placed on the internal tray 22 reaches the given number of sheets Np (YES in step S807).

By contrast, when the controller 100b determines that the number of sheets P that are placed on the internal tray 22 has reached the given number of sheets Np (YES in step S807), in step S808, the controller 100b causes the crimper 32′ to crimp the binding position B1 (corresponding to the first liquid application position B1) on the sheet bundle Pb to which the liquid has been applied by the liquid application unit 140. In step S808, the controller 100b also rotates the conveyance roller pair 15 to eject the crimped sheet bundle Pb to the second output tray 26.

In step S809, the controller 100b determines whether the number of sheet bundles Pb thus ejected to the second output tray 26 has reached the requested number of copies Mp indicated by the post-processing command. When the controller 100b determines that the number of the sheet bundles Pb ejected to the second output tray 26 has not reached the requested number of copies Mp (NO in step S809), the controller 100b repeats the processing of steps S802 to S809 until the number of the sheet bundles Pb ejected to the second output tray 26 reaches the requested number of copies Mp (YES in step S809).

When the controller 100b determines that the number of sheet bundles Pb ejected to the second output tray 26 reaches the requested number of copies Mp (YES in step S809), in step S810, the controller 100b drives the liquid-applier movement motor 137 to move the liquid application unit 140 to the standby position HP1 (see FIG. 42B) and drives the crimper movement motor 238 to move the crimper 32′ to the standby position HP2 (see FIG. 40A). When the posture that is instructed by the post-processing operation is the “oblique binding posture,” in step S810, the controller 100b drives the application-head pivot motor 150 and the crimper pivot motor 239 to rotate the liquid application unit 140 and crimper 32′ and the parallel binding posture (standby angle) into the parallel binding posture. By contrast, when the posture that is instructed by the post-processing command is the “parallel binding posture,” the controller 100b skips the aforementioned operation of rotating the liquid application unit 140 and the crimper 32′ to the parallel binding posture (standby angle). In steps S801 and S810, the execution order of the movement in the main scanning direction and the rotation in both forward and reverse directions of the liquid application unit 140 and the crimper 32′ is not limited to the aforementioned order and may be reversed.

The present disclosure may be applied not only to the edge binder 251 that executes edge binding but also to the saddle binder 28 that executes saddle stitching.

The controller 100b of the post-processing apparatus 3A according to the second embodiment illustrated in FIG. 39 is provided separately from the controller 100a of the image forming apparatus 2 as in the configuration of FIG. 1. However, no limitation is indicated thereby. For example, in a similar manner to FIG. 48A, the controller 100b of the post-processing apparatus 3A may be disposed in the image forming apparatus 2. Further, as in the configuration of FIG. 48B, the controller 100b of the post-processing apparatus 3A may be integrated with the controller 100a of the image forming apparatus 2.

In a similar manner to FIG. 49A, the controller 100b of the post-processing apparatus 3A may be divided into a controller 100b1 (e.g., a driver system such as a motor) and a controller 100b2 (a sensor system such as a sensor) according to the function, and the controller 100b2 of the post-processing apparatus 3A may be disposed in the image forming apparatus 2. Further, as in the configuration of FIG. 49B, the controller 100b2 of the post-processing apparatus 3A disposed in the image forming apparatus 2 may be integrated with the controller 100a of the image forming apparatus 2.

As described above, the control method by the controller 100b described above is implemented by cooperation between hardware resources of a computer and a program as computer software. In other words, the control method may be executed by causing an arithmetic device, a storage device, an input device, an output device, and a control device to operate in cooperation with each other based on a program. The program may be written in, for example, a storage device or a storage medium and distributed with the storage device or the storage medium, or may be distributed through, for example, an electric communication line.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. It is therefore to be understood that the above-described embodiments of the present disclosure may be practiced otherwise by those skilled in the art than as specifically described herein. Such modifications and variations are included in the technical scope described in the appended claims.

As described above, with the medium processing apparatus according to the embodiments of the present disclosure, the number of times binding is performed for one sheet bundle Pb can be changed depending on the type or kind of post-processing, and the binding force or binding strength and the speed of binding, which corresponds to the productivity, can be adjusted to have a desired value. Accordingly, the customer convenience and the productivity of binding increase.

Aspects of the present disclosure are, for example, as follows.

### First Aspect

A medium processing apparatus includes a liquid applier including a liquid application member to apply liquid to at least one of a plurality of media through the liquid application member, and a postprocessor to execute post-processing on a medium bundle including the plurality of media to which the liquid is applied. The liquid applier moves the liquid application member to contact the at least one of the plurality of media and apply the liquid to the media, and adjusts a position of the liquid application member on at least one of the plurality of media to make an amount of the liquid applied from the liquid application member to at least one of the plurality of media constant before and after the liquid application member is worn.

### Second Aspect

In the medium processing apparatus according to the first aspect, when the liquid is applied to at least one of the plurality of media, the liquid applier changes the position of the liquid application member based on pressing force on the at least one of the plurality of media applied by the liquid application member.

### Third Aspect

In the medium processing apparatus according to the first aspect or the second aspect, the liquid applier changes the position of the liquid application member based on pressing force applied to a lower pressure plate on which the plurality of media are placed.

### Fourth Aspect

The medium processing apparatus according to any one of the first to third aspects further includes a movable part on a lower pressure plate on which the plurality of media are placed, and the liquid applier measures the pressing force based on an amount of pushing movement caused when the liquid application member contacts the movable part.

### Fifth Aspect

In the medium processing apparatus according to any one of the first to fourth aspects, the liquid applier changes a standby position of the liquid application member based on a height of the liquid application member before and after the liquid application member is worn.

### Sixth Aspect

In the medium processing apparatus according to the fourth aspect, the liquid applier changes the position of the liquid application member before the liquid is applied, based on a height of the liquid application member before and after the liquid application member is worn.

### Seventh Aspect

In the medium processing apparatus according to any one of the first to sixth aspects, the liquid applier changes an end position of the liquid application member facing the at least one of the plurality of media based on height data or pressing force of the liquid application member before and after the liquid application member is worn.

### Eighth Aspect

In the medium processing apparatus according to any one of the first to seventh aspects, the liquid applier stores the liquid application member to a reference position, and pushes the liquid application member from the reference position by a prescribed amount.

### Ninth Aspect

An image forming system includes an image forming apparatus to form an image on a medium, and the medium processing apparatus according to any one of the first to eighth aspects to perform post-processing on the medium on which the image is formed by the image forming apparatus.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

What is claimed is:

1. A medium processing apparatus comprising:
a liquid applier including a liquid application member to apply liquid to a medium through the liquid application member; and
a postprocessor to execute post-processing on a medium bundle including the medium to which the liquid is applied,
wherein the liquid applier
moves the liquid application member to contact the medium and apply the liquid to the medium, and
adjusts a position of the liquid application member on the medium to make an amount of the liquid applied from the liquid application member to the medium constant before and after the liquid application member is worn.

2. The medium processing apparatus according to claim 1,
wherein, when the liquid is applied to the medium, the liquid applier changes the position of the liquid application member based on pressing force on the medium applied by the liquid application member.

3. The medium processing apparatus according to claim 1,
wherein the liquid applier changes the position of the liquid application member based on pressing force applied to a lower pressure plate on which the medium is placed.

4. The medium processing apparatus according to claim 3, further comprising
a movable part on the lower pressure plate on which the medium is placed,
wherein the liquid applier measures the pressing force based on an amount of pushing movement caused when the liquid application member contacts the movable part.

5. The medium processing apparatus according to claim 1,
wherein the liquid applier changes a standby position of the liquid application member based on a height of the liquid application member before and after the liquid application member is worn.

6. The medium processing apparatus according to claim 4,
wherein the liquid applier changes the position of the liquid application member before the liquid is applied, based on a height of the liquid application member before and after the liquid application member is worn.

7. The medium processing apparatus according to claim 1,
wherein the liquid applier changes an end position of the liquid application member facing the medium based on height data or pressing force of the liquid application member before and after the liquid application member is worn.

8. The medium processing apparatus according to claim 1,
wherein the liquid applier stores the liquid application member to a reference position, and pushes the liquid application member from the reference position by a prescribed amount.

9. An image forming system comprising:
an image forming apparatus to form an image on a medium; and
the medium processing apparatus according to claim 1 to perform post-processing on the medium on which the image is formed by the image forming apparatus.
